(19) United States
(12) Patent Application Publication
(10) Pub. No.: US 2014/0194188 A1
(43) Pub. Date: Jul. 10, 2014

(54) PERSON-TO-PERSON WAGERING SYSTEM USING ACCOMPLISHMENT-BASED GAMES AND APPLICATIONS TO RECORD SCORE, ACHIEVEMENT OR TIME IN AN ASYNCRONOUS MANNER USING PUBLIC OR PRIVATE NETWORKS

(71) Applicants: James Peter Kosta, Gardnerville, NV (US); William Joseph McMaster, Las Vegas, NV (US)

(72) Inventors: James Peter Kosta, Gardnerville, NV (US); William Joseph McMaster, Las Vegas, NV (US)

(73) Assignee: CENTENNIAL CORPORATION, LLC, Reno, NV (US)

(21) Appl. No.: 14/152,901

(22) Filed: Jan. 10, 2014

Related U.S. Application Data
(60) Provisional application No. 61/751,228, filed on Jan. 10, 2013.

(51) Int. Cl. G07F 17/32

(52) U.S. Cl. CPC G07F 17/3262
USPC 463/25

(57) ABSTRACT

Various techniques are described for facilitating implementation and use of accomplishment-based games or applications for wager-based challenges (collectively “Game” or “Challenge”) for the purpose of facilitating person-to-person, business-to-business, and/or business-to-consumer wagering in an asynchronous environments.

### RELATED APPLICATION DATA

The present application claims benefit, pursuant to the provisions of 35 U.S.C. §119, of U.S. Provisional Application Ser. No. 61/751,228 (Attorney Docket No. ODTYP002P), titled “PERSON-TO-PERSON WAGERING SYSTEM USING ACCOMPLISHMENT-BASED GAMES AND APPLICATIONS TO RECORD SCORE, ACHIEVEMENT OR TIME IN AN ASYNCRONOUS MANNER USING PUBLIC OR PRIVATE NETWORKS”, naming Kosta et al. as inventors, and filed 10 Jan. 2013, the entirety of which is incorporated herein by reference for all purposes.

### BACKGROUND

The present disclosure relates to applications and games whose users are connected to a shared server back-end. More particularly, the present disclosure relates to accomplishment-based wagering based on scores, achievements or time-based events tracked within the application or game which may be wagered on in a person-to-person manner.

### BRIEF DESCRIPTION OF THE DRAWINGS

FIG. 1 illustrates a simplified block diagram of a specific example embodiment of a portion of a Computer Network 100.

FIG. 2 is a simplified block diagram of an exemplary gaming machine 200 in accordance with a specific embodiment.

FIG. 3 shows a diagrammatic representation of machine in the exemplary form of a client (or end user) computer system 300.

FIG. 4 is a simplified block diagram of an exemplary Mobile Device 400 in accordance with a specific embodiment.

FIG. 5 illustrates an example embodiment of a Server System 580 which may be used for implementing various aspects/features described herein.

FIG. 6 illustrates an example of a functional block diagram of a Server System 600 in accordance with a specific embodiment.

FIG. 7 shows a specific example of an embodiment of a gaming network 700 which may be used for implementing various features.

FIG. 8 shows a specific embodiment of an example data flow diagram illustrating various action between various devices/systems of an accomplishment-based wagering gaming network.

FIG. 9 shows a block diagram illustrating components of a gaming network 900 which may be used for implementing various aspects of example embodiments

### DETAILED DESCRIPTION OF EXAMPLE EMBODIMENTS

### Overview

Various aspects described or referenced herein are directed to different methods, systems, and computer program products for facilitating implementation and use of accomplishment-based games or applications (collectively “Game”) for the purpose of person-to-person wagering in asynchronous environments.

One aspect disclosed herein is directed to different computer-based methods, systems, and computer program products for implementing accomplishment-based wagering techniques in wagering or gaming networks. In at least one embodiment, various method(s), system(s) and/or computer program product(s) may be operable to: cause a controller of a computerized wagering system to execute a plurality of instructions, which are stored in a memory device, to control a first wager-based gaming session; enable a Challenge Initiator to selectively customize and define an accomplishment-based, wager-based Challenge Offer (“Challenge Offer”), the Challenge Offer defining a first set of accomplishment criteria and defining a first set of wager criteria; receive, at the computerized wagering system, a first request to initiate the Challenge Offer; receive, at the computerized wagering system, information relating to the Challenge Offer including the first set of accomplishment criteria and first set of wager criteria; publish the Challenge Offer to at least one challenger; receive, at the computerized wagering system, a first Challenge Offer acceptance from a first challenger desiring to participate in the Challenge Offer; automatically initiating, in response to detection of a first set of conditions and/or events, a start of a first accomplishment-based, wager-based challenge session (“first challenge session”) associated with the Challenge Offer; enable the first challenger to participate in the first challenge session; automatically initiating, in response to detection of a second set of conditions and/or events, an end of the first challenge session; automatically determine a final outcome or result of the first challenge session; and/or automatically distribute, using information relating to the final outcome or result of the first challenge session, wager-related winnings and/or losses to the first challenger and Challenge Initiator.

In other embodiments, various method(s), system(s) and/or computer program product(s) may be operable to facilitate, enable, initiate, and/or perform one or more of the following operation(s), action(s), and/or feature(s) (or combinations thereof): automatically determine wager distributions relating to the first challenge session which are to be distributed to the first challenger and Challenge Initiator, wherein the determination of the wager distributions is at least partially based upon the final outcome or result of the first challenge session; verify, at the computerized wagering system and using the wager criteria, that the Challenge Initiator has provided access to a sufficient amount fungible resources to cover a first Challenge wager as defined by the first set of wager criteria; verify, at the computerized wagering system and using the wager criteria, that the first challenger has provided access to a sufficient amount fungible resources to cover a second Challenge wager as defined by the first set of wager criteria; enable the first challenger to selectively customize and define Challenge Counter Offer, the Challenge Counter Offer defining a first set of modified accomplishment criteria and/or defining a first set of modified wager criteria; submit, via the computerized wagering system, the Challenge Counter Offer to the Challenge Initiator; automatically track status updates relating to asynchronous events, conditions, and/or activities associated with one or more challenge session(s) associated with a given Challenge Offer; and/or prevent publication of the Challenge Offer in response to determine that the first set of accomplishment criteria and/or the first set of wager criteria is not in compliance with a first set of rules or regulations.

Various objects, features and advantages of the various aspects described or referenced herein will become apparent from the following descriptions of its example embodiments, which descriptions should be taken in conjunction with the accompanying drawings.

### SPECIFIC EXAMPLE EMBODIMENTS

Various techniques will now be described in detail with reference to a few example embodiments thereof as illustrated in the accompanying drawings. In the following description, numerous specific details are set forth in order to provide a thorough understanding of one or more aspects and/or features described or reference herein. It will be apparent, however, to one skilled in the art, that one or more aspects and/or features described or reference herein may be practiced without some or all of these specific details. In other instances, well known process steps and/or structures have not been described in detail in order to not obscure some of the aspects and/or features described or reference herein.

One or more different inventions may be described in the present application. Further, for one or more of the invention(s) described herein, numerous embodiments may be described in this patent application, and are presented for illustrative purposes only. The described embodiments are not intended to be limiting in any sense. One or more of the invention(s) may be widely applicable to numerous embodiments, as is readily apparent from the disclosure. These embodiments are described in sufficient detail to enable those skilled in the art to practice one or more of the invention(s), and it is to be understood that other embodiments may be utilized and that structural, logical, software, electrical and other changes may be made without departing from the scope of the one or more of the invention(s). Accordingly, those skilled in the art will recognize that the one or more of the invention(s) may be practiced with various modifications and alterations. Particular features of one or more of the invention(s) may be described with reference to one or more particular embodiments or figures that form a part of the present disclosure, and in which are shown, by way of illustration, specific embodiments of one or more of the invention(s). It should be understood, however, that such features are not limited to usage in the one or more particular embodiments or figures with reference to which they are described. The present disclosure is neither a literal description of all embodiments of one or more of the invention(s) nor a listing of features of one or more of the invention(s) that must be present in all embodiments.

Headings of sections provided in this patent application and the title of this patent application are for convenience only, and are not to be taken as limiting the disclosure in any way.

Devices that are in communication with each other need not be in continuous communication with each other, unless expressly specified otherwise. In addition, devices that are in communication with each other may communicate directly or indirectly through one or more intermediaries.

A description of an embodiment with several components in communication with each other does not imply that all such components are required. To the contrary, a variety of optional components are described to illustrate the wide variety of possible embodiments of one or more of the invention(s).

Further, although process steps, method steps, algorithms or the like may be described in a sequential order, such processes, methods and algorithms may be configured to work in alternate orders. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the invention(s), and does not imply that the illustrated process is preferred.

When a single device or article is described, it will be readily apparent that more than one device/article (whether or not they cooperate) may be used in place of a single device/article. Similarly, where more than one device or article is described (whether or not they cooperate), it will be readily apparent that a single device/article may be used in place of the more than one device or article.

The functionality and/or the features of a device may be alternatively embodied by one or more other devices that are not explicitly described as having such functionality/features. Thus, other embodiments of one or more of the invention(s) need not include the device itself.

Techniques and mechanisms described or reference herein will sometimes be described in singular form for clarity. However, it should be noted that particular embodiments include multiple iterations of a technique or multiple instantiations of a mechanism unless noted otherwise.

Various aspects described or referenced herein are directed to different methods, systems, and computer program products for facilitating implementation and use of accomplishment-based games or applications for wager-based challenges (collectively “Game” or “Challenge”) for the purpose of facilitating person-to-person, business-to-business, and/or business-to-consumer wagering in an asynchronous environments. For example, in at least one embodiment, a game playable on a video game console connected to a television may allow a player who has achieved a high position on the game's Leaderboard, to wager real or virtual currency/items that they may retain that position for a given period of time. Likewise, the system could notify the user's friends and allow them to wager that they may beat the user's score. After a period of time, the system may determine the user(s) who has/have achieved the best score(s) and distribute the winnings accordingly.

Systems employing one or more of the accomplishment-based wagering techniques disclosed herein may be configured or designed to enable individual players to select the amount and/or type of wager, and to define, identify and/or otherwise select the achievement criteria/parameters to be associated with the accomplishment-based wagering Challenge. For example, in at least some embodiments, the accomplishment-based wagering systems may be configured or designed to enable the players to define desired wagering parameters and/or achievement criteria by selecting from a list of parameters/criteria (e.g., provided by an accomplishment-based wagering system server), and/or by establishing or defining their own unique wager and achievement parameters/criteria in an ad-hoc fashion. Examples of such wager and/or achievement parameters/criteria may include, but are not limited to, one or more of the following (or combinations thereof):
score-based criteria;
time-based accomplishments;
time-based criteria;
achievement-based criteria;
accumulated results;
wager amounts;
wager types;
game type criteria;
payout parameters;
criteria relating to the number of participants allowed to participate in the Challenge;
criteria relating to the types of participants allowed to participate in the Challenge;
location-based criteria;
Challenge duration criteria;
social networking based criteria;
statistic-based criteria (e.g., stats based on externally verifiable facts, conditions, and/or events such as, for example: Reno will have more rainfall over the next week than Las Vegas)
etc.

Such wagering techniques could also include a method of handicapping or setting of odds. Further, the techniques may also allow users who do not actively play the Game, or those who feel they can't beat the challenge, to wager on the ultimate outcome by selecting the person or people they feel may win. This wager may be accumulated into the shared funds (“Pot”), or set aside as a separate wager (“Side Wager”).

For example, in at least one embodiment, a Game may be configured or designed to provide a person (“Player”) playing to achieve a specific goal. Upon Player achieving the goal, the player may be presented with the option of wagering that none of their friends may achieve the goal in a set time period.

The techniques also allow for the operator of the system to take part of the wager activity (“Rake”), therefore the “Pot” and “Side Wagers” may be reduced accordingly.

Although in most embodiments, the Game may allow the Player to wager after they have achieved a goal, in embodiments which are determined by a proprietary ranking (e.g., “Leaderboard”), the Player may post a wager on the Forward Looking Results (FLR).

Unlike conventional gaming tournaments which take place synchronously in a controlled environment, these techniques allow for asynchronous competition utilizing a server system which tracks player ranking and friendships. Specifically, the users do not need to be logged into the Game at the same time.

### Time-Based Wagers (TBW)

In at least one embodiment, a Time-Based Wagers (TBW) Game may be defined as a game or application in which there are goals which may be met in a predetermined or accumulated timeframe. When the Player achieves a specific goal, they are given the opportunity to wager that their friends (or the public) cannot beat their time (“Challenge”). The Player's wager gets put into a Pot. When other users (“Challenger(s)”) decide to take the Challenge, they may wager a certain amount of money or items. This wager is added to the Pot.

To simplify the understanding of this concept we may use the game of Virtual MAZE as an example. In this example we purpose that the game may be played on a networked “System” which allows stand-alone (local) or Online/Connected (multi-player) game play. This is the standard model for the majority of modern console video games regardless of manufacture/developer.

In the following example embodiments, it is assumed that the gaming “System” is capable of creating and managing games, schedules, player accounts, connecting players, sharing information etc. Additionally, although process steps, method steps, actions, operations, algorithms or the like may be described in a sequential order, such processes, methods and algorithms may be configured to work in alternate orders. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the invention(s), and does not imply that the illustrated process is preferred.

### TWB Example A

In this example Player 1 Completed MAZE Game Level 10 in a VERY short time for them “5 mins”, and feels they have mastered the game. Player 1 issues a Public Challenge. In the particular example, it is assumed that Player 1 creates the following Challenge and posts it online for a specific time limit.

### Action(s) 1A—

The System creates and issues the Challenge.
“Player 1 welcomes all corners to compete in a Time Based Wager competition for MAZE Level 10.
Interested parties may accept challenge and post wager amount by 5 pm PST on Mar. 26, 2012.”

“Challenge Details”
“Challenge Acceptance Window”
Challenge Issue Date: Mar. 25, 2012 (10 am PST)
Challenge Closure Date: Mar. 26, 2012 (5 pm PST)

“Active Competition Window”
Start Time—9 am PST, Mar. 27, 2012
End Time—4 pm PST, Mar. 27, 2012.
Wager Amount $20.00US

“Challenge Details”
Game=MAZE Level 10
Complete MAZE Level 10 in 5 minutes or less. (Fastest Time Takes All)
Game Rules=Standard MAZE Game—Level 10.
Error or malfunction during game may NOT void play.

### Action(s) 2A—

The “System” posts the “Challenge” to each of the registered players “Public” and manages the connections, registrations, and wagers, etc.
During this “Challenge Acceptance Window” two players accept the challenge . . . Player 2 & Player 3 and submit their wager amounts.

### Action(s) 3A—

The “Challenge Acceptance Window” Closes and each of the participating players are reminded of the details:
Dear Player X—you are participating in an upcoming challenge!
You have Wagered $20.00
The total challenge Award may be $54.00

“Active Competition Window”
Start Time—9 am PST, Mar. 27, 2012
End Time—4 pm PST, Mar. 27, 2012.
Your wager amount $20.00US

“Challenge Details”
Game=MAZE—Level 10
Complete in 5 minutes or less
Game Rules=Standard MAZE Game—Level 10.
Error or malfunction during game play may NOT void play.
All Games must be started before the Competition Window closes to qualify.

### Action(s) 4A—

The Active Competition Window opens and Player 3 begins his Game @ 10 am PST.
Player 3 has a great Game and beats the Challenge by completing MAZE Level 10 in just 4 minutes and 15 seconds.

### Action(s) 5A—

Player 3 is notified by the “System” that they have qualified for the Challenge by beating the 5 minute time limit and that they are currently in 1^{st} place.
They are also reminded that there are other Players yet to compete and that all participants may be notified of the results once the competition window ends.

### Action(s) 6A—

Player 2 begins their game @ 3:50 pm PST. They have a good game, but fail to meet the challenge minimum, completing the MAZE level 10 in 7 minutes.
They are immediately notified that they did NOT meet the challenge and may NOT win the Award.

### Action(s) 7A—

The Competition Window Closes and the results are posted/all participants are notified of the results: Players 1 & 2 lose the Challenge and their wager amounts of $20 ea. Player 3 WINS the challenge and is awarded $54.00.
In this embodiment it is shown that the “System” takes a 10% commission of the total wagered amount for the challenge, this is variable and may be adjusted as required for regulatory compliance. e.g . . . .
   # of Players=3
   Amount of individual wager $20.00
   Total wagered amount for challenge=$60.00
   Less System Commission —$6.0
   Total Challenge Award=$54.00
System activate, Game and Challenge Status may be managed via real-time statistics updates/postings and/or via individual messages.

### TWB Example B—

### Time Based Wager Challenge with Re-Buy Opportunity

For ease of illustration, the next example operates in a very similar manner to the first example but allows for Players to buy “Wager Packs” or the amount of attempts they may want to retry for a better score/time. In a single wager model embodiment, the wager and pot may be fixed by the time the “Active Competition Window” begins.
EX B1=1 wager per player entry & 1 game session/attempt per player.
   E.g.:
   # of Players=3
   Amount of individual wager $20.00
   Total wagered amount for challenge=$60.00
   Less System Commission —$6.0
   Total Challenge Award=$54.00
This information may be made available to each participant before the Competition begins and they know exactly what the total Risk/Reward opportunity is.
EX B2—This is somewhat variable, a Player upon registering for the completion may be given the opportunity to purchase multiple attempts (or “Wager-Packs”). In at least one embodiment, the amount may be limited. For example, in one example, it may be assumed that a player dynamically defines and offers the following wager options.
   1-Single attempt ($20.00)
   3 Play Pack ($60.00)
   5 Play Pack ($100.00)
In one embodiment, this may be configured or designed to work as a pre-purchase only, meaning that if a Player is successful or happy with their first game, they simply accept the end result and are refunded the remaining unused attempts/wagers.
E.g.: For this example it may be assumed that one of the 3 Players purchases a Wager Pack 3.
The Challenge Information at beginning of the Competition may be:
   # of Players=3
   Wager breakdown;
      Player 1=Wager Pack 1
      Player 2=Wager Pack 3
      Player 3=Wager Pack 1}
   Amount of individual wager
      Player 1=$20.00
      Player 2=$60.00
      Player 3=$20.00
   Total POTENTIAL wagered amount for challenge=$100.00
   Total POTENTIAL Challenge Award=$90.00
   Potential System Commission —$10.0

In this example Player 1 Completed MAZE Game Level 10 in a VERY short time for them “5 mins”, and feels they have mastered the game. Player 1 issues a Public Challenge. In this particular example, it is assumed that Player 1 creates the following Challenge and posts it online for a specific time limit.

### Action(s) 1B—

The System creates and issues the Challenge.
“Player 1 welcomes all corners to compete in a Time Based Wager competition for MAZE Level 10.
Interested parties may accept challenge and post wager amount by 5 pm PST on Mar. 26, 2012.”

“Challenge Details”
“Challenge Acceptance Window”
Challenge Issue Date: Mar. 25, 2012 (10 am PST)
Challenge Closure Date: Mar. 26, 2012 (5 pm PST)

“Active Competition Window”
Start Time—9 am PST, Mar. 27, 2012
End Time—4 pm PST, Mar. 27, 2012.
Wager Amount $20.00US

“Challenge Details”
Game=MAZE Level 10
Complete MAZE Level 10 in 5 minutes or less. (Fastest Time Takes All)
Game Rules=Standard MAZE Game—Level 10.
Error or malfunction during game may NOT void play.

### Action(s) 2B—

The “System” posts the “Challenge” to all registered players “Public” and manages the connections, registrations, and wagers, etc.
During this “Challenge Acceptance Window” two players accept the challenge . . . Player 2 & Player 3 and submit their wager amounts.

### Action(s) 3B—

The “Challenge Acceptance Window” Closes and each of the participating players are reminded of their details:
Dear Player 1—you are participating in an upcoming challenge!
You have Wagered $20.00
The total challenge Award may be from $54.00-$90.00

“Active Competition Window”
Start Time—9 am PST, Mar. 27, 2012
End Time—4 pm PST, Mar. 27, 2012.
Your wager amount $20.00US

“Challenge Details”
Game=MAZE—Level 10
Complete in 5 minutes or less
Game Rules=Standard MAZE Game—Level 10.
Error or malfunction during game play may NOT void play.
All Games must be started before the Competition Window closes to qualify.

### Action(s) 4B—

The Active Competition Window opens and Player 3 begins his Game @ 10 am PST.
Player 3 has a great Game and beats the Challenge by completing MAZE Level 10 in just 4 minutes and 15 seconds.

### Action(s) 5B—

Player 3 is notified by the “System” that they have qualified for the Challenge by beating the 5 minute time limit and that they are currently in 1^{st} place.
They are also reminded that there are other Players yet to compete and that one or more participants may be notified of the results once the competition window ends.

### Action(s) 6B—

Player 2 begins their game @ 3:50 pm PST. They have a good game, but fail to meet the challenge minimum, completing the MAZE level 10 in 7 minutes.
They are immediately notified that they did NOT meet the challenge and may NOT win the Award with this game, however, because they purchased a Wager Pack 3, they two more attempts available. Would they like to use attempt #2?
Player 2 Begins Attempt 2 . . . and completes the MAZ level 10 in 4 minutes and 50 seconds.
Player 2 is comfortable with their time and chooses NOT to use their 3^{rd} attempt. (Player 2 is notified that the System is returning $20.00 to their account for the unused attempt)

### Action(s) 7B—

The Competition Window Closes and the results are posted/all participants are notified of the results:
   Players 1—Challenge Maker Time=5 mins
   Player 2—Attempts=2 Best time 4:50 Seconds
   Player 3=WINNER w/a Time of 4 mins and 15 seconds.
Player's 1 & 2 lose the Challenge and Player 3 WINS the challenge and is awarded $72.00.
In this embodiment it is shown that the “System” takes a 10% commission of the total wagered amount for the challenge, this is variable and may be adjusted as required for regulatory compliance. e.g . . . .
   # of Players=3
   Amount of individual wagers
      Player 1=$20.00
      Player 2=$40.00 (Purchased—3 attempts, and only used 2)
      Player 3=$20.00
   Total wagered amount for challenge=$80.00
   Total Challenge Award=$72.00
   System Commission —$8.0
System activate, Game and Challenge Status may be managed via real-time statistics updates/postings and/or via individual messages.

### Point-Based Wagers (PBW)

In at least one embodiment, a Point-Based Wagers (PBW) Game may be defined as a game or application in which there are points that accumulate to reflect the session or accumulated total of the Player's efforts. When the Player reaches a predetermined or relative point value, they are given the opportunity to wager that their friends (or the public) cannot beat their point value or score (“Challenge”). The Player's wager gets put into a Pot. When other users (“Challenger(s)”) decide to take the Challenge, they may wager a certain amount of money or items. This wager is added to the Pot.

To simplify the understanding of this concept we may use the game of Virtual Pinball as an example. In this example we purpose that the game may be played on a networked “System” which allows stand-alone (local) or Online/Connected (multi-player) game play. This is the standard model for the majority of modern console video games regardless of manufacture/developer.

For purposes of illustration, it is assumed in the example that the gaming system is capable of creating and managing games, schedules, player accounts, connecting players, sharing information etc.

### PBW Example C

In this example Player 1 feels they have mastered the game Pinball-x, “Game” after being #1 on the local game's leaderboard they decide to issues a Public Challenge. In this particular example, it is assumed that Player 1 creates the following Challenge and posts it online for a specific time limit.

### Action(s) 1C—

The System creates and issues the Challenge.
“Player 1 Welcomes all corners to compete in a Hi-Score Wager competition for Pinball-X
Interested parties may accept challenge and post wager amount by 5 pm PST on Mar. 26, 2012.”

“Challenge Details”
“Challenge Acceptance Window”
Challenge Issue Date: Mar. 25, 2012 (10 am PST)
Challenge Closure Date: Mar. 26, 2012 (5 pm PST)

“Active Competition Window”
Start Time—9 am PST, Mar. 27, 2012
End Time—4 pm PST, Mar. 27, 2012.
Wager Amount $20.00US

“Challenge Details”
Game=Pinball-x
Earn 10,000 or more points (High Score Takes All)
Game Rules=1 Standard 5-ball session
Single Session max—60 second pause between ball launches.
Error or malfunction during game may NOT void play.

### Action(s) 2C—

The “System” posts the “Challenge” to all registered players “Public” and manages the connections, registrations, and wagers, etc.
During this “Challenge Acceptance Window” two players accept the challenge . . . Player 2 & Player 3 and submit their wager amounts.

### Action(s) 3C—

The “Challenge Acceptance Window” Closes and each of the participating players are reminded of the details:
Dear Player X—you are participating in an upcoming challenge!
You have Wagered $20.00
The total challenge Award may be $54.00

“Active Competition Window”
Start Time—9 am PST, Mar. 27, 2012
End Time—4 pm PST, Mar. 27, 2012.
Your wager amount $20.00US

“Challenge Details”
Game=Pinball-x
Earn 10,000 or more points
Game Rules=1 Standard 5-ball session
Single Session max—60 second pause between ball launches.
Error or malfunction during game play may NOT void play.—All Games must be started before the Competition Window closes to qualify.

### Action(s) 4C—

The Active Competition Window opens and Player 3 begins his Game @ 10 am PST.
Player 3 has a great Game Session and beats the Challenge with a final score of 11200 points, as their game ends.

### Action(s) 5C—

Player 3 is notified by the “System” that they have qualified for the Challenge by beating the 10,000 point minimum, and that they are currently in 1^{st} place.
They are also reminded that there are other Players yet to compete and that all participants may be notified of the results once the competition window ends.

### Action(s) 6C—

Player 2 begins their game @ 3:50 pm PST. They have a good game, but fail to meet the challenge minimum, ending the game with a score of 9,500 points.
They are immediately notified that they did NOT meet the challenge and may NOT win the Award.

### Action(s) 7C—

The Competition Window Closes and the results are posted/All participants are notified of the results: Players 1 & 2 lose the Challenge and their wager amounts of $20 ea. Player 3 WINS the challenge and is awarded $54.00.
In this embodiment it is shown that the “System” takes a 10% commission of the total wagered amount for the challenge, this is variable and may be adjusted as required for regulatory compliance. e.g . . . .
   # of Players=3
   Amount of individual wager $20.00
   Total wagered amount for challenge=$60.00
   Less System Commission —$6.0
   Total Challenge Award=$54.00
System activate, Game and Challenge Status may be managed via real-time statistics updates/postings and/or via individual messages.

### Achievement-Based Wagers (ABW)

In at least one embodiment, an Achievement-Based Wagers (ABW) Game may be defined as a game or application in which there are goals which the player may meet to earn recognition or special status. When the Player achieves a specific goal, they are given the opportunity to wager that their friends (or the public) cannot beat their achievement and/or cannot achieve the same goal in less time (“Challenge”). The Player's wager gets put into a Pot. When other users (“Challenger(s)”) decide to take the Challenge, they may wager a certain amount of money or items. This wager is added to the Pot.

### Example

### Accomplishment-Based Wager System (ABWS) for Corporate/Marketing Promotions

According to different embodiments, companies, corporations, and/or other business entities may leverage one or more of the features and/or benefits of the accomplishment-based wagering techniques for corporate marketing and targeted promotions across multiple business areas. The illustrative example use case scenario below provides one example of how a company may leverage the accomplished-based wagering techniques to achieve an easy to use, automatically monitored, and verifiable system for transacting corporate marketing and targeted promotions across multiple business areas.

For purposes of illustration, it is assumed in the following example that a company (e.g., NIKE®) wishes to conduct a targeted marketing campaign for one of its products (e.g., Nike Fuel Band product) via initiation of an accomplishment-based wagering Challenge. In this particular example, it is further assumed that the company's product relates to a consumer exercise tracking product, and that the company has established a user base for the product via online & mobile applications. The company is now looking to create a huge social media buzz and increase its user base and product utilization with a robust marketing promotion. The company has the ability to track and monitor their own product usage and application but no way of effectively monitoring, tracking and reporting on various the social media activities and events of its user base. The following example challenge scenario is illustrated of one example embodiment of the type of complex Marketing promotions which may be effectively implemented using the accomplishment-based wagering techniques disclosed herein.

### Example Social Marketing Challenge Offer

### Stage 1—Minimum Challenge Achievement Criteria Requirement

Participants who accept the Challenge Offer and log over 20 Miles and 50 k points in a “defined week/period” using the company's exercise tracking product and mobile application will be rewarded with $20.

[Note: defining the minimum challenge achievement criteria in this way intrinsically incentivizes the target audience to increase usage and promotion of the company's product(s), service(s), and software]

### Stage II—Social Media Challenge Achievement Criteria

Tier A—Challenge Participants who complete Stage 1—and who post their Challenge results on Facebook will win and additional $10.
Tier B—Challenge Participants who complete Stage 1—and who also place in the top 3 by generating the most re-tweets on Twitter regarding this product usage and Challenge, will win and additional $100.
Tier C—Challenge Participants who complete Stage 1—and who also post a photo on Instagram regarding this product usage and Challenge, and who also receive more than 25 comments on the Instagram post, will win and additional $100.

[Note: In at least one embodiment, it is possible for a Challenge Participant to successfully complete the social media challenge achievement criteria of Tiers A, B, and/or C, thereby allowing a challenge participant to potentially win up to an additional $210 in this Stage II]

### Stage III—Cream of the Crop

Challenge Participants who complete Stage 1 and who place within the top 3 of two or more Stage II events will win an additional $200 award.

### Stage IV—Grand Champion

The Challenge Participants who completes Stage 1, and who has successfully completed each of the Stage II Challenge Tiers, and who has generated the most social media buzz regarding the Challenge-related posts which that person posted to Facebook, Twitter, and Instagram (e.g., as defined, for example, as an aggregate of the total number Facebook “likes”+Facebook comments+Twitter re-tweets+Instagram comments), is crowned Grad Champion and wins an addition $1000, plus a trip to the Company's HQ with a full media blitz.

### Statistical and Forward Looking Results (FLR)

In at least one embodiment, a Forward Looking Results (FLR) Game may allow for the placing of wagers based on statistical or forward looking results which may be objectively and factually verified at the end of a Challenge session. For example, a Wagerer may place a wager and issue a Challenge to their friends or the public based on the anticipated makeup of the Game's Leaderboard after a predetermined period of time. In some embodiments, these types of Challenges may not begin until multiple Challenger(s) have agreed to participate. An example of a statistical-based Challenge (e.g., based on externally verifiable facts, conditions, and/or events) may be a Challenge Offer from a Challenge Initiator who wagers anyone $5 that Reno, Nev. will receive more rainfall than Boulder, Colo. over the Challenge duration (e.g., 7 days).

### Side Wagers

In at least one embodiment, a Side Wagers Game may allow for the placing of Side Wagers, or wagers which are not added to the pot. These are typically placed by non-participants in the Game, although they may be used by participants to increase their wagering position. Side Wagers are placed for or against the Player and/or specific Challenger(s). Side Wagers may also include additional goals which are not part of the primary Challenge.

For example: A Player may post a wager that they may retain the top spot on a Game's Leaderboard for 24 hours. A non-participant could post a Side Wager that the Player may retain the spot for less than 12 hours. Any participant or non-participant may accept the wager and place a wager in support or opposition. In order to be a recognized Side Wager, and in the spirit of a person-to-person based system, a Side Wager should preferably have an opposing wager to be valid.

### Distributions

In at least one embodiment, the Pot distribution occurs immediately if the Challenger(s) beat the Challenge. In this instance, no further attempts at the Challenge are possible. In at least one other embodiment, the Challenge remains active until a certain time has passed, at which point the Pot is distributed. For example, some possible outcomes are:
Challenger(s) fail to beat the Challenge. The Pot is paid to the Player.
One of more Challenger(s) are successful and the Pot is split evenly.
One of more Challenger(s) are successful and the Pot is split based on a secondary scoring system, or based on the relation of at least one Challenger's accomplishments to the Challenge overall.

In at least one embodiment, the Side Wager distribution occurs immediately if the Challenger(s) beat the Challenge. In this instance, no further attempts at the Challenge are possible. In at least one other embodiment, the Challenge remains active until a certain time has passed, at which point the Side Wager is distributed. For example, some possible outcomes are:
Challenger(s) fail to beat the Challenge. The Side Wager is paid to the Wagerer(s) who wagered on the Player.
One of more Challenger(s) are successful and the Side Wager is split evenly between

Wagerer(s) who wager on the Challenger(s).
One of more Challenger(s) are successful and the Side Wager is split based on a secondary scoring system, or based on the relation of at least one Challenger's accomplishments to the Challenge overall.
In one embodiment, wagerer(s) who wagered on a specific Challenger may be paid only if that Challenger is successful.
In one embodiment, wagerer(s) could also have wagers against a specific Challenger and may be paid only if that Challenger fails.

### Accomplishment-Based Wagering Embodiments

As disclosed previously, various aspects described or referenced herein are directed to different methods, systems, and computer program products for facilitating implementation and use of accomplishment-based games or applications for wager-based challenges (collectively “Game” or “Challenge”) for the purpose of facilitating person-to-person, business-to-business, and/or business-to-consumer wagering in an asynchronous environments. For example, in at least one embodiment, a game or application may be used to accrue points toward a goal. Upon reaching that goal, the user (“Player”) may be asked to post a wager if they feel their friends cannot meet the same goal. The Player's friends (“Challenger(s)”) are notified of the goal (“Challenge”) and are given the opportunity to wager a real and/or virtual currency and/or items for a chance to beat the Challenge. If successful, the Challenger(s) may win one or more or a portion of the collective wagers (“Pot”).

For example, in at least one embodiment, a Game may include wagering features that allow:
the Player to wager on his/her friends' or the public's ability to match the Player's accomplishments;
a Challenger to accept the Challenge and post a wager, then attempt to beat the Challenge;
a non-participant (neither Player or Challenger) to post and participate in Side Wagers related to the Challenge.

According to specific embodiments, accomplishment-based wagering techniques may be implemented using various different methods, systems, computer program products, etc., and may be implemented in a manner which adds additional wagering options and levels of wagering complexity. For example, according to different embodiments, a variety of different accomplishment-based wagering Challenges may be created and/or implemented using on one or more of the following types of accomplishment-based criteria (or combinations thereof):
Time-based accomplishment criteria;
Point/score-based accomplishment criteria;
Activity/Achievement-based wagers;
Forward looking results criteria;
Side wager criteria;
Etc.

According to different embodiments, different types of accomplishment-based wagering techniques may be implemented in and/or applied to a variety of different types of games, applications, and or other activities which, for example, may include, but are not limited to, one or more of the following (or combinations thereof):
Racing/Driving (Cars, boats, planes etc.)
Sports (Football, Baseball, downhill skiing, etc.
Challenge games (Archery, Darts, Shooting, etc.)
Recreation Games (Horseshoes, Croquet, Fishing etc.
Arcade-type Games etc.
Smartphone Applications
Computer-based Applications
Statistical and/or Factually Verifiable Events
Wager-based (e.g., casino-type) games/events
Geocaching applications
Exercise or Weight-loss applications
Travel applications
Social Gaming activities
Social Networking activities
And/or any other types of games or applications in which accomplishments are recorded and shared.

For example, according to different embodiments, one or more of the various game or application types described herein may be adapted and/or modified to be an accomplishment-based wagering system in which the game or application status of a user is determined in relation to another user or users and the results are wagered upon. In one embodiment, the user may have the opportunity to wager on their accomplishments directly in the game or application itself. However, in at least one embodiment, the wagering system may be external to the game or application, but may have the ability to record accomplishments that are published by the game or application.

Additionally, according to different embodiments, a variety of different entity types may initiate and/or participate in one or more different accomplishment-based wagering Challenges. Collectively, the initiator(s) and participants of an accomplishment-based wagering Challenge may be referred to as “Wagerers,” even in cases where an amount to be wagered by a participant is zero (such as in marketing or promotional Challenges, for example). Examples of different entity types which may initiate and/or participate in one or more different accomplishment-based wagering Challenges may include, but are not limited to, one or more of the following (or combinations thereof):
Individual persons;
Groups or collectives comprising multiple persons;
Business entities such as companies, corporations, enterprises, etc.;
Institutions
Governmental Agencies
Religious organizations;
Political organizations;
etc.

For example, an initiator of an accomplishment-based wagering Challenge may be an individual, a corporation, or other types of entities. Similarly participants in an accomplishment-based wagering Challenge may include individuals, corporations, and/or other types of entities.

### Benefits, Features, and Advantages of Accomplishment-Based Wagering Techniques

Many of the accomplishment-based wagering techniques disclosed herein may be implemented as an API or third party solution on the client side, thereby easily utilizing popular existing games and applications and not requiring the client side game/app to be specifically designed or developed for wagering.
Unlike today's commercially available digital wagering systems, systems employing one or more of the accomplishment-based wagering techniques disclosed herein may not require an always on or constant connection between the clients and the system, since, for example, such systems may be asynchronously driven by messages, alerts, pre-established time frames, etc.
Systems employing one or more of the accomplishment-based wagering techniques disclosed herein may be configured or designed to generate, track, and maintain a full log/audit trail of the gaming session(s). For example, in at least one embodiment, the game play related events, wager related events, and/or other desired events may each be captured and logged in a fully transactional manner. Additionally, such systems may be configured or designed to provide players with receipt confirmation(s) or acknowledgement(s) of every (or selected) move(s) that each player submits.
Systems employing one or more of the accomplishment-based wagering techniques disclosed herein may be configured or designed to enable individual players to select the amount and/or type of wager, and to define, identify and/or otherwise select the achievement criteria/parameters to be associated with the accomplishment-based wagering Challenge. For example, in at least some embodiments, the accomplishment-based wagering systems may be configured or designed to enable the players to define desired wagering parameters and/or achievement criteria by selecting from a list of parameters/criteria (e.g., provided by an accomplishment-based wagering system server), and/or by establishing or defining their own unique wager and parameters in an ad-hoc fashion. In contrast, in many of today's commercially available wagering systems, the parameters for the wager (win or loss requirements) are either embedded in the games or are predetermined, leaving the players to only choose the “amount” of their wager.
Another advantageous aspect of the accomplishment-based wagering techniques disclosed herein is the ability for the individual players to establish and agree upon the time(s) or duration(s) of their wager(s). In some embodiments, this may also include a forfeiture time period, in which, if a player dose not record a move or activity within a specified period of time, that player's wager may be automatically forfeited.
The asynchronous nature of the accomplishment-based wagering systems disclosed herein is significantly different than the wagering techniques currently employed by today's commercially available wagering systems. For example, one or more of the accomplishment-based wagering systems disclosed herein may be configured or designed to provide players the ability to play the accomplishment-based wagering game/app at their own pace (within the established and agreed upon parameters of the wager/game), and in a completely secure and transactional environment. The accomplishment-based wagering techniques may also allow for multiple players (e.g., 3 or more players) to participate in games and/or wagers that, traditionally have only be available between 2 players.
In at least some embodiments, one or more of the accomplishment-based wagering systems disclosed herein may be configured or designed to present or display active leaderboard GUIs, which, for example, may be configured or designed to show game and/or wager related trend lines. By way of illustration, in one example, about half way into a given game, the leaderboard GUIs may present information which indicates that one player currently has a significant lead or advantage over the one or more other player(s). For example, the leaderboard GUIs may be automatically and/or dynamically updated to reflect that Players 1 has completed his or her move, now has a 60% advantage over Player 2. Thereafter, after a few more moves by each player have been completed, the leaderboard GUIs may be automatically and/or dynamically updated to reflect that Player 3 has now leaped ahead of the other players. It will be appreciated that such features enable and facilitate completely new and unique types of leaderboard embodiments and interactivity in gaming systems.
Players have the ability to selectively play and wager against desired friends and/or other persons.
Game and application users may become more engaged and vested in their usage of the game or application.
The accomplishment-based wagering techniques disclosed herein take advantage of the fact that Person-To-Person wagering is typically not regulated in most global territories, and is interpreted as being legal in the United States when there are no odds-making or house-sponsored wagering.
One or more wagers and/or wager-related parameters may be dynamically defined and/or determined by the Players. If a player does not present a fair and achievable Challenge, the wager may simply expire.
In friend-to-friend wagering, there may be no requirements for a particular game or application to be certified as providing fair and consistent odds or results. Players may be considered to be informed of the rules and mechanics of the game or application in question.

### Accomplishment-Based Wagering Example 1

### (Racing)—Get the Gold Medal in a Car Race

In a particular example, it is assumed that the Player is playing a racing game which simulates a car race. The player has chosen the track, opponents and car configuration.
The Player successfully wins first place in the race.
The Player is offered the opportunity to place a wager on their friends' ability to accomplish the same goal under the same conditions. He/she accepts and posts five USD into the Pot. The Player also specifies that each Challenger may have five attempts to beat the challenge and the wager for doing so is one USD.
The Player's friends are notified through various means (text messages, email, etc.) that there is a Challenge available. The terms of the Challenge are shared. It is up to the player to make them attractive.
One of the Player's friends decides to take the Challenge. The friend may wager a percentage of the Player's wager. In this case, the friend wagers one USD that they may win the race within five attempts.
The Challenger starts the race with on the same track, against the same opponents and using the same car configuration.
If the Challenger beats the Player the Challenger wins the Pot (six USD) and the Challenge is over.
If the Challenger fails, their wager goes into the Pot. If another Challenger wagers and beats the Challenge, that challenger may win the collective Pot (seven USD).
If no Challenger beats the Challenge in the allotted time from, the Pot is paid to the Player.

### Accomplishment-Based Wagering Example 2

### (Exercise Application)—Walk the Most Next Week

In a particular example, it is assumed that the Player utilizes a smart-phone application that tracks how far they walk at least one day.
The Player is offered the opportunity to place a wager on their and their friends' ability to walk a long distance over the course of one week. He/she accepts the opportunity and wagers that they may purchase a meal for any Challenger(s) who beat them in the Challenge.
Because the Player is issuing a Challenge based on Forward Looking Results, and their success is not assured, the Player may also be referred to as a Challenger.
The Player's friends are notified through various means (text messages, email, etc.) that there is a Challenge available. The terms of the Challenge are shared. It is up to the player to make them attractive.
One of the Player's friends decides to take the Challenge. The friend also wagers that they may pay for a shared meal.
After several Challenger(s) have signed up, or a specific time period passes, the Challenge begins.
At the end of the Challenge, the person (or persons) at the bottom of the Leaderboard buy a shared meal for the other Challenger(s).

### Accomplishment-Based Wagering Example 3

### (Arcade Game)—Get the Highest Score

In a particular example, it is assumed that the Player plays an arcade game which accumulates a session score based on game mechanics.
The Player is offered the opportunity to place a wager on their and their friends' ability to get to the top of the Leaderboard and hold that position. He/she accepts the opportunity and wagers ten USD. He/she sets the length of the Challenge to 24 hours.
Because the Player is issuing a Challenge based on Forward Looking Results, and their success is not assured, the Player may also be referred to as a Challenger.
The Player's friends are notified through various means (text messages, email, etc.) that there is a Challenge available. The terms of the Challenge are shared. It is up to the player to make them attractive.
Several of the Player's friends decide to take the Challenge. They all wager ten USD.
After a predetermined number of Challenger(s) have signed up, or a specific time period passes, the Challenge begins.
The Challenger(s) play game to accumulate points and attempt to reach the top of the Leaderboard. The period of time that each Challenger holds onto the top position on the Leaderboard determines their percentage of the Pot. In this instance, each second that a Challenger remains at the top of the Leaderboard equates to 1/86400^{th} of the pot (24 hours*60 minutes/hour*60 seconds/minute=86400).
At the end of the Challenge, the Pot is split among the Challenger(s) who have earned shares of it.

Various aspects described or referenced herein are directed to different methods, systems, and computer program products for facilitating implementation and use of accomplishment-based wagering techniques for allowing users to wager with one another based on their accomplishments in an application or game, including multi-user gaming or social environments.

Various examples of multi-player games and/or multi-user gaming or social environments may include, but are not limited to, one or more of the following (or combinations thereof):
internet-based multi-player online (MMO) games such as, for example, World of Warcraft™ (www.worldofwarcraft.com), The Sims Online™ (www.thesims.com), etc.
multi-player games accessible via consumer-type game consoles such as Microsoft XBOX™, Sony Playstation™, Nintendo WII™, etc.
multi-player games accessible via mobile devices such as iOS devices, Android devices, Windows-Mobile devices, Symbian devices, etc.
multi-player wager-based games accessible via one or more casino gaming networks and/or other types of gaming networks;
multi-user social environments accessible through any electronic device, such as, for example, Facebook, LinkedIn, etc.
and/or other types of multi-player games or social systems which may be accessible to users/players via one or more other types of systems and/or networks.

According to different embodiments, one or more multi-user type games and applications may be configured or designed to include accomplishment-based wagering functionality for enabling one or more of the features and/or aspects described herein. For example, in one embodiment, an application on Facebook may be built to allow friends to wager against on shared or separate accomplishments.

For example, according to different embodiments, one or more multi-user type games and applications may be configured or designed to include accomplishment-based wagering functionality for facilitating, enabling; initiating, and/or performing one or more of the following operation(s), action(s), and/or feature(s) (or combinations thereof):

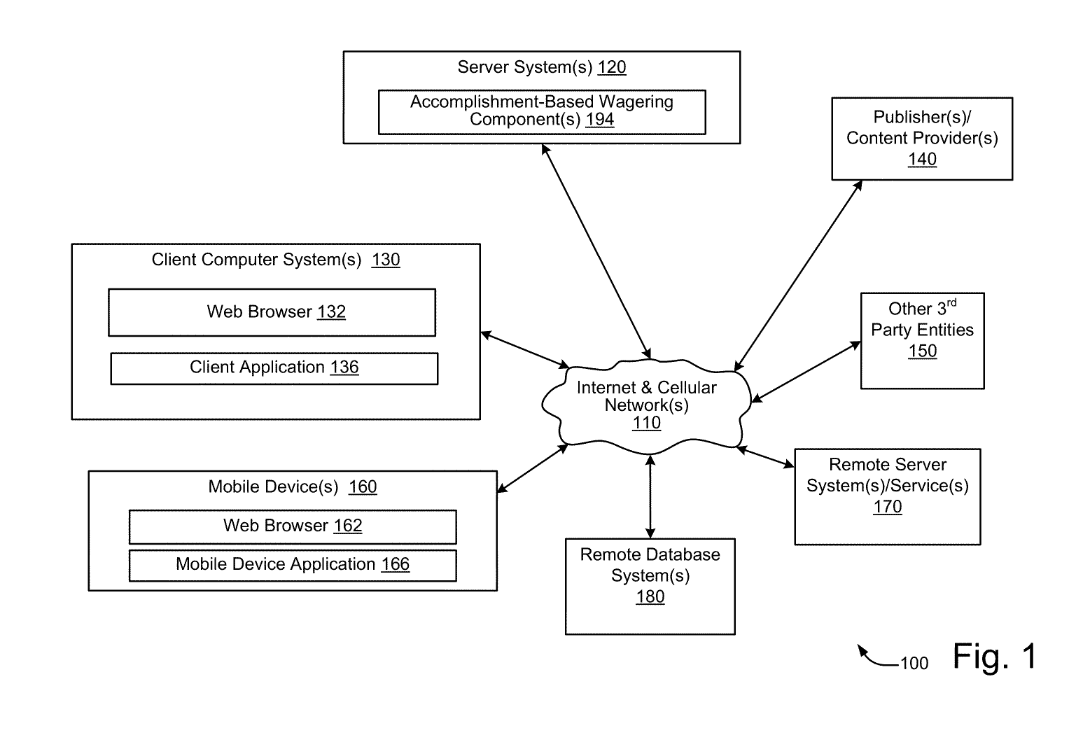

FIG. 1 illustrates a simplified block diagram of a specific example embodiment of a portion of a Gaming Network 100. As described in greater detail herein, different embodiments of computer networks may be configured, designed, and/or operable to provide various different types of operations, functionalities, and/or features generally relating to game event influence/outcome technology. Further, as described in greater detail herein, many of the various operations, functionalities, and/or features of the Gaming Network(s) disclosed herein may provide may enable or provide different types of advantages and/or benefits to different entities interacting with the Gaming Network(s).

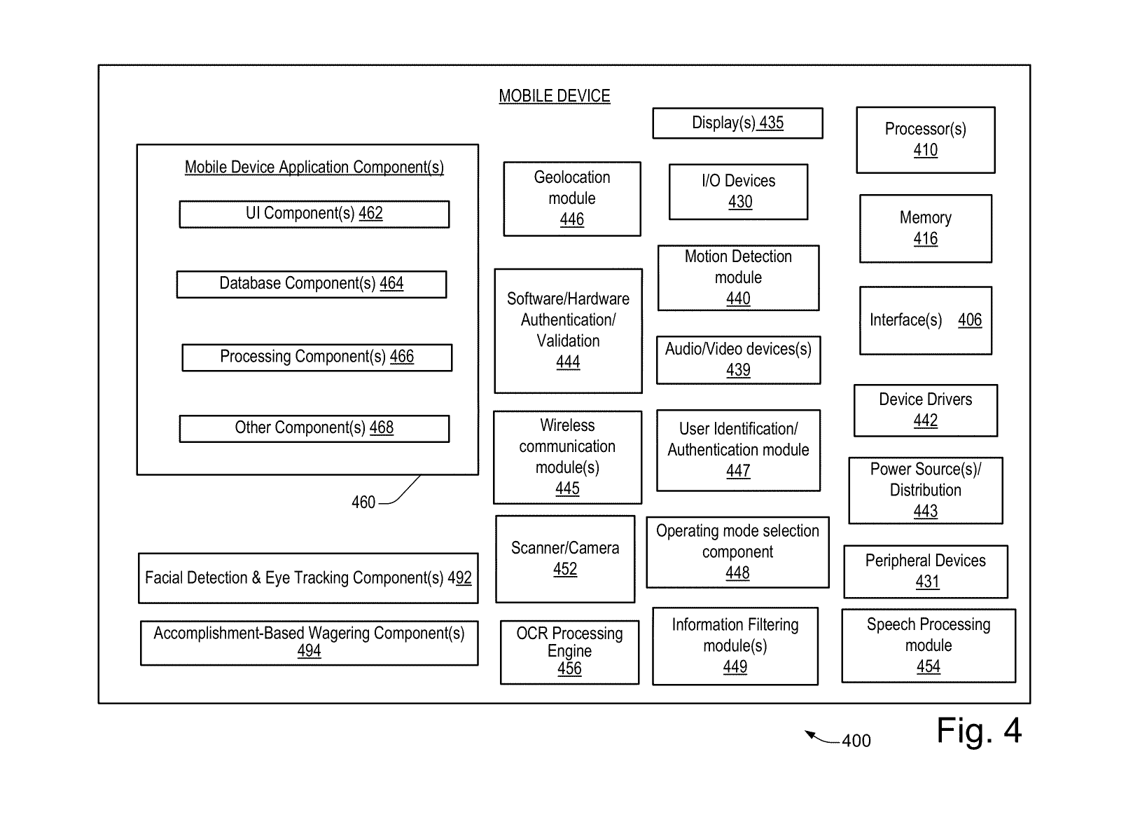

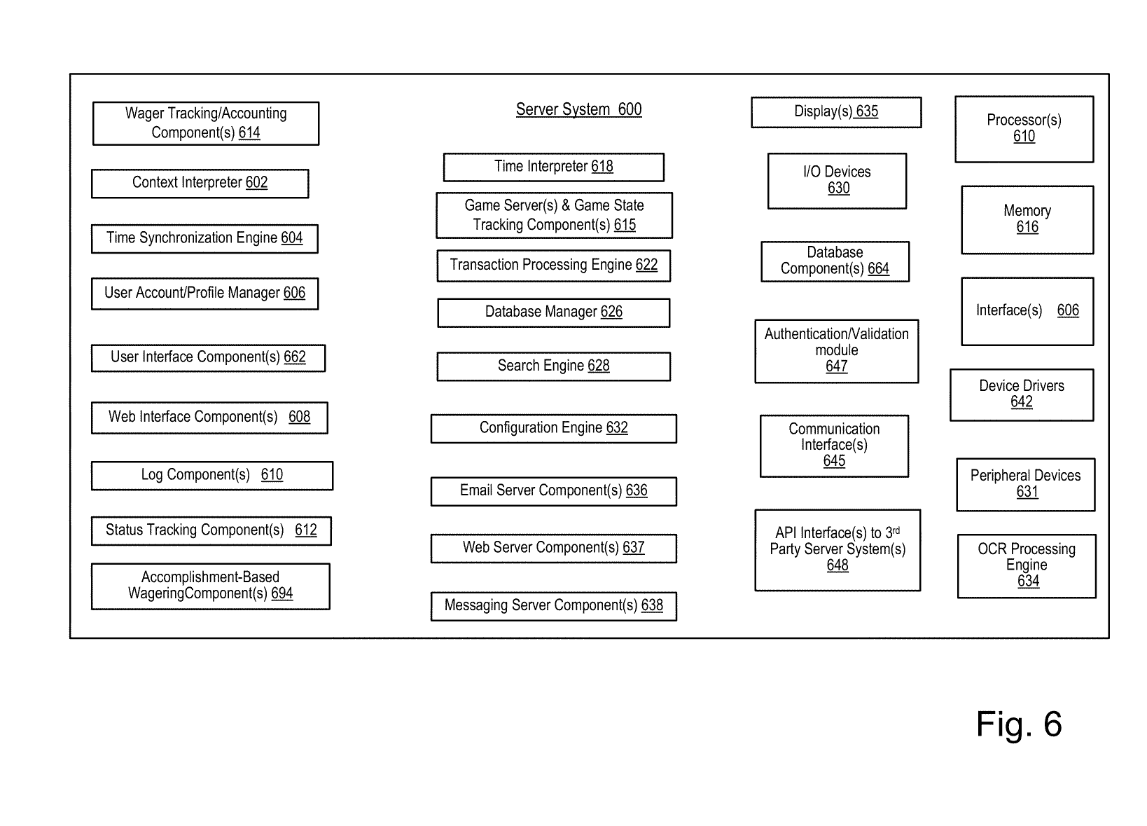

According to different embodiments, the Gaming Network 100 may include a plurality of different types of components, devices, modules, processes, systems, etc., which, for example, may be implemented and/or instantiated via the use of hardware and/or combinations of hardware and software. For example, as illustrated in the example embodiment of FIG. 1, the Gaming Network 100 may include one or more of the following types of systems, components, devices, processes, etc. (or combinations thereof):
Server System(s) 120—In at least one embodiment, the Server System(s) may be operable to perform and/or implement various types of functions, operations, actions, and/or other features such as those described or referenced herein (e.g., such as those illustrated and/or described with respect to FIG. 6). In at least one embodiment, Server System 120 may be configured or designed to include Accomplishment-Based Wagering Component(s) 194 for providing functionality relating to one or more of the accomplishment-based wagering techniques disclosed herein.
Publisher/Content Provider System component(s) 140
Client Computer System (s) 130
3^{rd} Party System(s) 150
Internet & Cellular Network(s) 110
Remote Database System(s) 180
Remote Server System(s)/Service(s) 170, which, for example, may include, but are not limited to, one or more of the following (or combinations thereof):
   Content provider servers/services
   Media Streaming servers/services
   Database storage/access/query servers/services
   Financial transaction servers/services
   Payment gateway servers/services
   Electronic commerce servers/services
   Event management/scheduling servers/services
   Etc.
Mobile Device(s) 160, which, for example, may include, but are not limited to, one or more of the following (or combinations thereof): gaming machines, vending machines, televisions, kiosks, consumer devices, smart phones, video game consoles, personal computer systems, electronic display systems, etc. In at least one embodiment, the Mobile Device(s) may be operable to perform and/or implement various types of functions, operations, actions, and/or other features such as those described or referenced herein (e.g., such as those illustrated and/or described with respect to FIG. 4).
etc.

In at least one embodiment, a Mobile Device may be operable to detect gross motion or gross movement of a user. For example, in one embodiment, a Mobile Device may include motion detection component(s) which may be operable to detect gross motion or gross movement of a user's body and/or appendages such as, for example, hands, fingers, arms, head, etc.

According to different embodiments, at least some Gaming Network(s) may be configured, designed, and/or operable to provide a number of different advantages and/or benefits and/or may be operable to initiate, and/or enable various different types of operations, functionalities, and/or features, such as, for example, one or more of those described or referenced herein.

According to different embodiments, at least a portion of the various types of functions, operations, actions, and/or other features provided by the Gaming Network 100 may be implemented at one or more client systems(s), at one or more server systems (s), and/or combinations thereof.

According to different embodiments, the Gaming Network may be operable to utilize and/or generate various different types of data and/or other types of information when performing specific tasks and/or operations. This may include, for example, input data/information and/or output data/information. For example, in at least one embodiment, the Gaming Network may be operable to access, process, and/or otherwise utilize information from one or more different types of sources, such as, for example, one or more local and/or remote memories, devices and/or systems. Additionally, in at least one embodiment, the Gaming Network may be operable to generate one or more different types of output data/information, which, for example, may be stored in memory of one or more local and/or remote devices and/or systems. Examples of different types of input data/information and/or output data/information which may be accessed and/or utilized by the Gaming Network may include, but are not limited to, one or more of those described and/or referenced herein.

According to specific embodiments, multiple instances or threads of the Gaming Network may be concurrently implemented and/or initiated via the use of one or more processors and/or other combinations of hardware and/or hardware and software. For example, in at least some embodiments, various aspects, features, and/or functionalities of the Gaming Network may be performed, implemented and/or initiated by one or more of the various systems, components, systems, devices, procedures, processes, etc., described and/or referenced herein.

In at least one embodiment, a given instance of the Gaming Network may access and/or utilize information from one or more associated databases. In at least one embodiment, at least a portion of the database information may be accessed via communication with one or more local and/or remote memory devices. Examples of different types of data which may be accessed by the Gaming Network may include, but are not limited to, one or more of those described and/or referenced herein.

According to different embodiments, one or more different threads or instances of the Gaming Network may be initiated in response to detection of one or more conditions or events satisfying one or more different types of minimum threshold criteria for triggering initiation of at least one instance of the Gaming Network. Various examples of conditions or events which may trigger initiation and/or implementation of one or more different threads or instances of the Gaming Network may include, but are not limited to, one or more of those described and/or referenced herein.

It may be appreciated that the Gaming Network of FIG. 1 is but one example from a wide range of Gaming Network embodiments which may be implemented. Other embodiments of the Gaming Network (not shown) may include additional, fewer and/or different components/features that those illustrated in the example Gaming Network embodiment of FIG. 1.

Generally, the game event influence/outcome techniques described herein may be implemented in hardware and/or hardware+software. For example, they may be implemented in an operating system kernel, in a separate user process, in a library package bound into network applications, on a specially constructed machine, or on a network interface card. In a specific embodiment, various aspects described herein may be implemented in software such as an operating system or in an application running on an operating system.

Hardware and/or software+hardware hybrid embodiments of the game event influence/outcome techniques described herein may be implemented on a general-purpose programmable machine selectively activated or reconfigured by a computer program stored in memory. Such programmable machine may include, for example, mobile or handheld computing systems, PDA, smart phones, notebook computers, tablets, netbooks, desktop computing systems, server systems, cloud computing systems, network devices, etc.

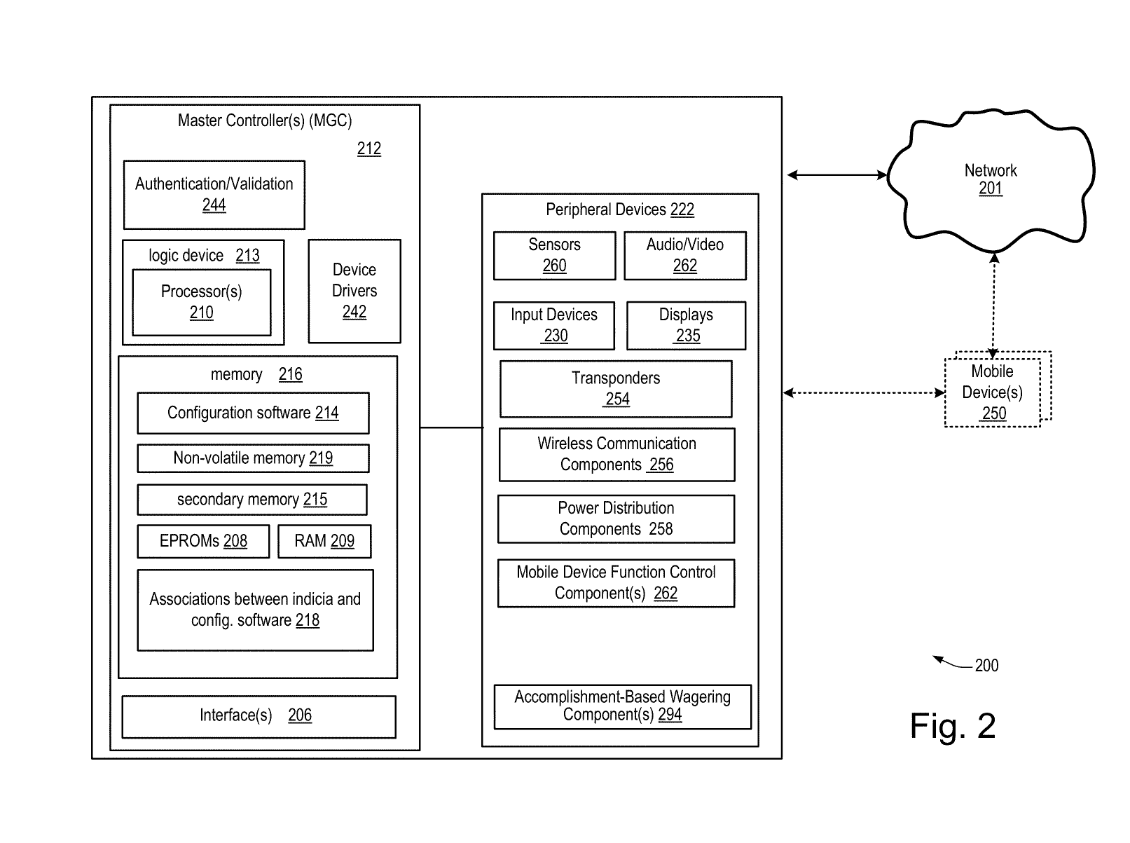

FIG. 2 is a simplified block diagram of an exemplary gaming machine 200 in accordance with a specific embodiment. As illustrated in the embodiment of FIG. 2, gaming machine 200 includes at least one processor 210, at least one interface 206, and memory 216.

In one implementation, processor 210 and master game controller 212 are included in a logic device 213 enclosed in a logic device housing. The processor 210 may include any conventional processor or logic device configured to execute software allowing various configuration and reconfiguration tasks such as, for example: a) communicating with a remote source via communication interface 206, such as a server that stores authentication information or games; b) converting signals read by an interface to a format corresponding to that used by software or memory in the gaming machine; c) accessing memory to configure or reconfigure game parameters in the memory according to indicia read from the device; d) communicating with interfaces, various peripheral devices 222 and/or I/O devices; e) operating peripheral devices 222 such as, for example, card readers, paper ticket readers, etc.; f) operating various I/O devices such as, for example, displays 235, input devices 230; etc. For instance, the processor 210 may send messages including game play information to the displays 235 to inform players of cards dealt, wagering information, and/or other desired information.

The gaming machine 200 also includes memory 216 which may include, for example, volatile memory (e.g., RAM 209), non-volatile memory 219 (e.g., disk memory, FLASH memory, EPROMs, etc.), unalterable memory (e.g., EPROMs 208), etc. The memory may be configured or designed to store, for example: 1) configuration software 214 such as one or more the parameters and settings for a game playable on the gaming machine; 2) associations 218 between configuration indicia read from a device with one or more parameters and settings; 3) communication protocols allowing the processor 210 to communicate with peripheral devices 222 and I/O devices 211; 4) a secondary memory storage device 215 such as a non-volatile memory device, configured to store gaming software related information (the gaming software related information and memory may be used to store various audio files and games not currently being used and invoked in a configuration or reconfiguration); 5) communication transport protocols (such as, for example, TCP/IP, USB, Firewire, IEEE1394, Bluetooth, IEEE 802.11x (IEEE 802.11 standards), hiperlan/2, HomeRF, etc.) for allowing the gaming machine to communicate with local and non-local devices using such protocols; etc. In one implementation, the master game controller 212 communicates using a serial communication protocol. A few examples of serial communication protocols that may be used to communicate with the master game controller include but are not limited to USB, RS-232 and Netplex (a proprietary protocol developed by IGT, Reno, Nev.).

A plurality of device drivers 242 may be stored in memory 216. Example of different types of device drivers may include device drivers for gaming machine components, device drivers for peripheral components 222, etc. Typically, the device drivers 242 utilize a communication protocol of some type that enables communication with a particular physical device. The device driver abstracts the hardware implementation of a device. For example, a device drive may be written for at least one type of card reader that may be potentially connected to the gaming machine. Examples of communication protocols used to implement the device drivers include Netplex, USB, Serial, Ethernet 275, Firewire, I/0 debouncer, direct memory map, serial, PCI, parallel, RF, Bluetooth™, near-field communications (e.g., using near-field magnetics), 802.11 (WiFi), etc. Netplex is a proprietary IGT standard while the others are open standards. According to a specific embodiment, when one type of a particular device is exchanged for another type of the particular device, a new device driver may be loaded from the memory 216 by the processor 210 to allow communication with the device. For instance, one type of card reader in gaming machine 200 may be replaced with a second type of card reader where device drivers for both card readers are stored in the memory 216.

In some embodiments, the software units stored in the memory 216 may be upgraded as needed. For instance, when the memory 216 is a hard drive, new games, game options, various new parameters, new settings for existing parameters, new settings for new parameters, device drivers, and new communication protocols may be uploaded to the memory from the master game controller 212 or from some other external device. As another example, when the memory 216 includes a CD/DVD drive including a CD/DVD designed or configured to store game options, parameters, and settings, the software stored in the memory may be upgraded by replacing a first CD/DVD with a second CD/DVD. In yet another example, when the memory 216 uses one or more flash memory 219 or EPROM 208 units designed or configured to store games, game options, parameters, settings, the software stored in the flash and/or EPROM memory units may be upgraded by replacing one or more memory units with new memory units which include the upgraded software. In another embodiment, one or more of the memory devices, such as the hard-drive, may be employed in a game software download process from a remote software server.

In some embodiments, the gaming machine 200 may also include various authentication and/or validation components 244 which may be used for authenticating/validating specified gaming machine components such as, for example, hardware components, software components, firmware components, information stored in the gaming machine memory 216, etc. Examples of various authentication and/or validation components are described in U.S. Pat. No. 6,620,047, titled, “ELECTRONIC GAMING APPARATUS HAVING AUTHENTICATION DATA SETS,” incorporated herein by reference in its entirety for one or more purposes.

Peripheral devices 222 may include several device interfaces such as, for example: transponders 254, wire/wireless power distribution components 258, input device(s) 230, sensors 260, audio and/or video devices 262 (e.g., cameras, speakers, etc.), transponders 254, wireless communication components 256, wireless power components 258, mobile device function control components 262, side wagering management components 264, etc.

Sensors 260 may include, for example, optical sensors, pressure sensors, RF sensors, Infrared sensors, image sensors, thermal sensors, biometric sensors, etc. Such sensors may be used for a variety of functions such as, for example detecting the presence and/or identity of various persons (e.g., players, casino employees, etc.), devices (e.g., mobile devices), and/or systems within a predetermined proximity to the gaming machine. In one implementation, at least a portion of the sensors 260 and/or input devices 230 may be implemented in the form of touch keys selected from a wide variety of commercially available touch keys used to provide electrical control signals. Alternatively, some of the touch keys may be implemented in another form which are touch sensors such as those provided by a touchscreen display. For example, in at least one implementation, the gaming machine player displays and/or mobile device displays may include input functionality for allowing players to provide desired information (e.g., game play instructions and/or other input) to the gaming machine, game table and/or other gaming system components using the touch keys and/or other player control sensors/buttons. Additionally, such input functionality may also be used for allowing players to provide input to other devices in the casino gaming network (such as, for example, player tracking systems, side wagering systems, etc.)

Wireless communication components 256 may include one or more communication interfaces having different architectures and utilizing a variety of protocols such as, for example, 802.11 (WiFi), 802.15 (including Bluetooth™), 802.16 (WiMax), 802.22, Cellular standards such as CDMA, CDMA2000, WCDMA, Radio Frequency (e.g., RFID), Infrared, Near Field Magnetic communication protocols, etc. The communication links may transmit electrical, electromagnetic or optical signals which carry digital data streams or analog signals representing various types of information.

Power distribution components 258 may include, for example, components or devices which are operable for providing wired or wireless power to other devices. For example, in one implementation, the power distribution components 258 may include a magnetic induction system which is adapted to provide wireless power to one or more mobile devices near the gaming machine. In one implementation, a mobile device docking region may be provided which includes a power distribution component that is able to recharge a mobile device without requiring metal-to-metal contact.

In at least one embodiment, mobile device function control components 262 may be operable to control operating mode selection functionality, features, and/or components associated with one or more mobile devices (e.g., 250). In at least one embodiment, mobile device function control components 262 may be operable to remotely control and/or configure components of one or more mobile devices 250 based on various parameters and/or upon detection of specific events or conditions such as, for example: time of day, player activity levels; location of the mobile device; identity of mobile device user; user input; system override (e.g., emergency condition detected); proximity to other devices belonging to same group or association; proximity to specific objects, regions, zones, etc.

In at least one embodiment, side wagering management components 264 may be operable to manage side wagering activities associated with one or more side wager participants. Side wagering management components 264 may also be operable to manage or control side wagering functionality associated with one or more mobile devices 250. In accordance with at least one embodiment, side wagers may be associated with specific events in a wager-based game that is uncertain at the time the side wager may be made. The events may also be associated with particular players, gaming devices (e.g., EGMs), game themes, bonuses, denominations, and/or paytables. In embodiments where the wager-based game is being played by multiple players, in one embodiment the side wagers may be made by participants who are not players of the game, and who are thus at least one level removed from the actual play of the game.

In instances where side wagers are made on events that depend at least in part on the skill of a particular player, it may be beneficial to provide observers (e.g., side wager participants) with information which is useful for determining whether a particular side wager may be placed, and/or for helping to determine the amount of such side wager. In at least one embodiment, side wagering management components 264 may be operable to manage and/or facilitate data access to player ratings, historical game play data, historical payout data, etc. For example, in one embodiment, a player rating for a player of the wager-based game may be computed based on historical data associated with past play of the wager-based game by that player in accordance with a pre-determined algorithms. The player rating for a particular player may be displayed to other players and/or observers, possibly at the option (or permission) of the player. By using player ratings in the consideration of making side wagers, decisions by observers to make side wagers on certain events need not be made completely at random. Player ratings may also be employed by the players themselves to aid them in determining potential opponents, for example.

Accomplishment-Based Wagering Component(s) 294 may be configured or designed to facilitate implementation and use of perceived skill gaming techniques for controlling game event influence and/or game outcomes in gaming environments. According to different embodiments, the Accomplishment-Based Wagering Component(s) may be configured or designed to include event influence/outcome functionality for facilitating implementation and use of perceived skill gaming techniques for controlling game event influence and/or game outcomes in gaming environments.

In other embodiments (not shown) other peripheral devices include: player tracking devices, card readers, bill validator/paper ticket readers, etc. Such devices may at least one comprise resources for handling and processing configuration indicia such as a microcontroller that converts voltage levels for one or more scanning devices to signals provided to processor 210. In one embodiment, application software for interfacing with peripheral devices 222 may store instructions (such as, for example, how to read indicia from a portable device) in a memory device such as, for example, non-volatile memory, hard drive or a flash memory.

In at least one implementation, the gaming machine may include card readers such as used with credit cards, or other identification code reading devices to allow or may require player identification in connection with play of the card game and associated recording of game action. Such a user identification interface may be implemented in the form of a variety of magnetic card readers commercially available for reading a user-specific identification information. The user-specific information may be provided on specially constructed magnetic cards issued by a casino, or magnetically coded credit cards or debit cards frequently used with national credit organizations such as VISA™, MASTERCARD™, banks and/or other institutions.

The gaming machine may include other types of participant identification mechanisms which may use a fingerprint image, eye blood vessel image reader, or other suitable biological information to confirm identity of the user. Still further it is possible to provide such participant identification information by having the dealer manually code in the information in response to the player indicating his or her code name or real name. Such additional identification could also be used to confirm credit use of a smart card, transponder, and/or player's mobile device.

It may be apparent to those skilled in the art that other memory types, including various computer readable media, may be used for storing and executing program instructions pertaining to the operation EGMs described herein. Because such information and program instructions may be employed to implement the systems/methods described herein, example embodiments may relate to machine-readable media that include program instructions, state information, etc. for performing various operations described herein. Examples of machine-readable media include, but are not limited to, magnetic media such as hard disks, floppy disks, and magnetic tape; optical media such as CD-ROM disks; magneto-optical media such as floptical disks; and hardware devices that are specially configured to store and perform program instructions, such as read-only memory devices (ROM) and random access memory (RAM). Example embodiments may also be embodied in a carrier wave traveling over an appropriate medium such as airwaves, optical lines, electric lines, etc. Examples of program instructions include both machine code, such as produced by a compiler, and files including higher level code that may be executed by the computer using an interpreter.

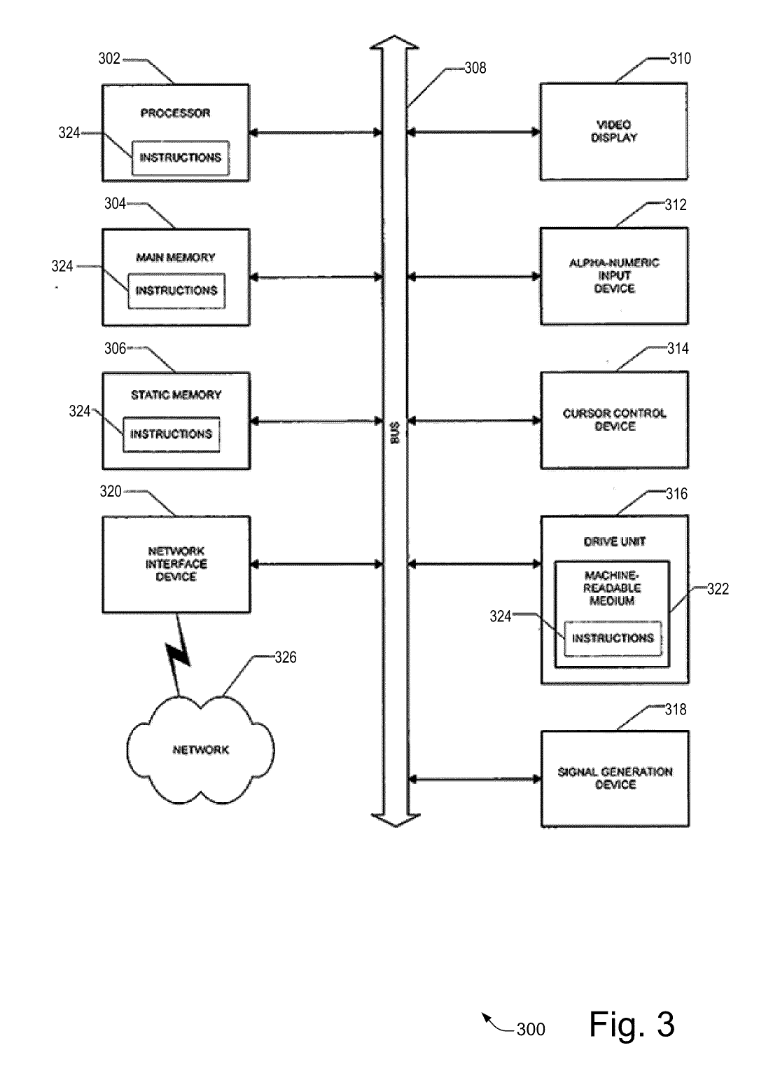

FIG. 3 shows a diagrammatic representation of machine in the exemplary form of a client (or end user) computer system 300 within which a set of instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” may also be taken to include any collection of machines that individually or jointly execute a set (or multiple sets) of instructions to perform any one or more of the methodologies discussed herein.

The exemplary computer system 300 includes a processor 302 (e.g., a central processing unit (CPU), a graphics processing unit (GPU) or both), a main memory 304 and a static memory 306, which communicate with at least one other via a bus 308. The computer system 300 may further include a video display unit 310 (e.g., a liquid crystal display (LCD) or a cathode ray tube (CRT)). The computer system 300 also includes an alphanumeric input device 312 (e.g., a keyboard), a user interface (UI) navigation device 314 (e.g., a mouse), a disk drive unit 316, a signal generation device 318 (e.g., a speaker) and a network interface device 320.

The disk drive unit 316 includes a machine-readable medium 322 on which is stored one or more sets of instructions and data structures (e.g., software 324) embodying or utilized by any one or more of the methodologies or functions described herein. The software 324 may also reside, completely or at least partially, within the main memory 304 and/or within the processor 302 during execution thereof by the computer system 300, the main memory 304 and the processor 302 also constituting machine-readable media.

The software 324 may further be transmitted or received over a network 326 via the network interface device 320 utilizing any one of a number of well-known transfer protocols (e.g., HTTP).

While the machine-readable medium 322 is shown in an exemplary embodiment to be a single medium, the term “machine-readable medium” may be taken to include a single medium or multiple media (e.g., a centralized or distributed database, and/or associated caches and servers) that store the one or more sets of instructions. The term “machine-readable medium” may also be taken to include any medium that is capable of storing, encoding or carrying a set of instructions for execution by the machine and that cause the machine to perform any one or more of the methodologies of the present invention, or that is capable of storing, encoding or carrying data structures utilized by or associated with such a set of instructions. The term “machine-readable medium” may accordingly be taken to include, but not be limited to, solid-state memories, optical and magnetic media, and carrier wave signals. Although an embodiment of the present invention has been described with reference to specific exemplary embodiments, it may be evident that various modifications and changes may be made to these embodiments without departing from the broader spirit and scope of the invention. Accordingly, the specification and drawings are to be regarded in an illustrative rather than a restrictive sense.

According to various embodiments, Client Computer System 300 may include a variety of components, modules and/or systems for providing various types of functionality. For example, in at least one embodiment, Client Computer System 300 may include a web browser application which is operable to process, execute, and/or support the use of scripts (e.g., JavaScript, AJAX, etc.), Plug-ins, executable code, virtual machines, vector-based web animation (e.g., Adobe Flash), etc.

In at least one embodiment, the web browser application may be configured or designed to instantiate components and/or objects at the Client Computer System in response to processing scripts, instructions, and/or other information received from a remote server such as a web server. Examples of such components and/or objects may include, but are not limited to, one or more of the following (or combinations thereof):
UI Components such as those illustrated, described, and/or referenced herein.
Database Components such as those illustrated, described, and/or referenced herein.
Processing Components such as those illustrated, described, and/or referenced herein.
Other Components which, for example, may include components for facilitating and/or enabling the Client Computer System to perform and/or initiate various types of operations, activities, functions such as those described herein.

In at least one embodiment, Client Computer System 300 may be configured or designed to include Accomplishment-Based Wagering functionality for facilitating implementation and use of perceived skill gaming techniques for controlling game event influence and/or game outcomes in gaming environments.

According to different embodiments, the Accomplishment-Based Wagering functionality may be configured or designed to facilitate implementation and use of perceived skill gaming techniques for controlling game event influence and/or game outcomes in gaming environments.

FIG. 4 is a simplified block diagram of an exemplary Mobile Device 400 in accordance with a specific embodiment. In at least one embodiment, the Mobile Device may be configured or designed to include hardware components and/or hardware+software components for enabling or implementing at least a portion of the various game event influence/outcome techniques described and/or referenced herein.

According to specific embodiments, various aspects, features, and/or functionalities of the Mobile Device may be performed, implemented and/or initiated by one or more of the following types of systems, components, systems, devices, procedures, processes, etc. (or combinations thereof): Processor(s) 410; Device Drivers 442; Memory 416; Interface(s) 406; Power Source(s)/Distribution 443; Geolocation module 446; Display(s) 435; I/O Devices 430; Audio/Video devices(s) 439; Peripheral Devices 431; Motion Detection module 440; User Identification/Authentication module 447; Client App Component(s) 460; Other Component(s) 468; UI Component(s) 462; Database Component(s) 464; Processing Component(s) 466; Software/Hardware Authentication/Validation 444; Wireless communication module(s) 445; Information Filtering module(s) 449; Operating mode selection component 448; Speech Processing module 454; Scanner/Camera 452; OCR Processing Engine 456; Accomplishment-Based Wagering Component(s) 492; etc.

As illustrated in the example of FIG. 4, Mobile Device 400 may include a variety of components, modules and/or systems for providing various types of functionality. For example, as illustrated in FIG. 4, Mobile Device 400 may include Mobile Device Application components (e.g., 460), which, for example, may include, but are not limited to, one or more of the following (or combinations thereof):
UI Components 462 such as those illustrated, described, and/or referenced herein.
Database Components 464 such as those illustrated, described, and/or referenced herein.
Processing Components 466 such as those illustrated, described, and/or referenced herein.
Other Components 468 which, for example, may include components for facilitating and/or enabling the Mobile Device to perform and/or initiate various types of operations, activities, functions such as those described herein.

In at least one embodiment, the Mobile Device Application component(s) may be operable to perform and/or implement various types of functions, operations, actions, and/or other features such as, for example, one or more of those described and/or referenced herein.

According to specific embodiments, multiple instances or threads of the Mobile Device Application component(s) may be concurrently implemented and/or initiated via the use of one or more processors and/or other combinations of hardware and/or hardware and software. For example, in at least some embodiments, various aspects, features, and/or functionalities of the Mobile Device Application component(s) may be performed, implemented and/or initiated by one or more of the various systems, components, systems, devices, procedures, processes, etc., described and/or referenced herein.

According to different embodiments, one or more different threads or instances of the Mobile Device Application component(s) may be initiated in response to detection of one or more conditions or events satisfying one or more different types of minimum threshold criteria for triggering initiation of at least one instance of the Mobile Device Application component(s). Various examples of conditions or events which may trigger initiation and/or implementation of one or more different threads or instances of the Mobile Device Application component(s) may include, but are not limited to, one or more of those described and/or referenced herein.

In at least one embodiment, a given instance of the Mobile Device Application component(s) may access and/or utilize information from one or more associated databases. In at least one embodiment, at least a portion of the database information may be accessed via communication with one or more local and/or remote memory devices. Examples of different types of data which may be accessed by the Mobile Device Application component(s) may include, but are not limited to, one or more of those described and/or referenced herein.

According to different embodiments, Mobile Device 400 may further include, but is not limited to, one or more of the following types of components, modules and/or systems (or combinations thereof):
At least one processor 410. In at least one embodiment, the processor(s) 410 may include one or more commonly known CPUs which are deployed in many of today's consumer electronic devices, such as, for example, CPUs or processors from the Motorola or Intel family of microprocessors, etc. In an alternative embodiment, at least one processor may be specially designed hardware for controlling the operations of the client system. In a specific embodiment, a memory (such as non-volatile RAM and/or ROM) also forms part of CPU. When acting under the control of appropriate software or firmware, the CPU may be responsible for implementing specific functions associated with the functions of a desired network device. The CPU preferably accomplishes one or more these functions under the control of software including an operating system, and any appropriate applications software.
Memory 416, which, for example, may include volatile memory (e.g., RAM), non-volatile memory (e.g., disk memory, FLASH memory, EPROMs, etc.), unalterable memory, and/or other types of memory. In at least one implementation, the memory 416 may include functionality similar to at least a portion of functionality implemented by one or more commonly known memory devices such as those described herein and/or generally known to one having ordinary skill in the art. According to different embodiments, one or more memories or memory modules (e.g., memory blocks) may be configured or designed to store data, program instructions for the functional operations of the client system and/or other information relating to the functionality of the various game event influence/outcome techniques described herein. The program instructions may control the operation of an operating system and/or one or more applications, for example. The memory or memories may also be configured to store data structures, metadata, timecode synchronization information, audio/visual media content, asset file information, keyword taxonomy information, advertisement information, and/or information/data relating to other features/functions described herein. Because such information and program instructions may be employed to implement at least a portion of the game event influence/outcome techniques described herein, various aspects described herein may be implemented using machine readable media that include program instructions, state information, etc. Examples of machine-readable media include, but are not limited to, magnetic media such as hard disks, floppy disks, and magnetic tape; optical media such as CD-ROM disks; magneto-optical media such as floptical disks; and hardware devices that are specially configured to store and perform program instructions, such as read-only memory devices (ROM) and random access memory (RAM). Examples of program instructions include both machine code, such as produced by a compiler, and files containing higher level code that may be executed by the computer using an interpreter.
Interface(s) 406 which, for example, may include wired interfaces and/or wireless interfaces. In at least one implementation, the interface(s) 406 may include functionality similar to at least a portion of functionality implemented by one or more computer system interfaces such as those described herein and/or generally known to one having ordinary skill in the art. For example, in at least one implementation, the wireless communication interface(s) may be configured or designed to communicate with selected electronic game tables, computer systems, remote servers, other wireless devices (e.g., PDAs, cell phones, player tracking transponders, etc.), etc. Such wireless communication may be implemented using one or more wireless interfaces/protocols such as, for example, 802.11 (WiFi), 802.15 (including Bluetooth™), 802.16 (WiMax), 802.22, Cellular standards such as CDMA, CDMA2000, WCDMA, Radio Frequency (e.g., RFID), Infrared, Near Field Magnetics, etc.
Device driver(s) 442. In at least one implementation, the device driver(s) 442 may include functionality similar to at least a portion of functionality implemented by one or more computer system driver devices such as those described herein and/or generally known to one having ordinary skill in the art.
At least one power source (and/or power distribution source) 443. In at least one implementation, the power source may include at least one mobile power source (e.g., battery) for allowing the client system to operate in a wireless and/or mobile environment. For example, in one implementation, the power source 443 may be implemented using a rechargeable, thin-film type battery. Further, in embodiments where it is desirable for the device to be flexible, the power source 443 may be designed to be flexible.
Geolocation module 446 which, for example, may be configured or designed to acquire geolocation information from remote sources and use the acquired geolocation information to determine information relating to a relative and/or absolute position of the client system.
Motion detection component 440 for detecting motion or movement of the client system and/or for detecting motion, movement, gestures and/or other input data from user. In at least one embodiment, the motion detection component 440 may include one or more motion detection sensors such as, for example, MEMS (Micro Electro Mechanical System) accelerometers, that may detect the acceleration and/or other movements of the client system as it is moved by a user.
User Identification/Authentication module 447. In one implementation, the User Identification module may be adapted to determine and/or authenticate the identity of the current user or owner of the client system. For example, in one embodiment, the current Functionality for enabling a user to be required to perform a log in process at the client system in order to access one or more features. Alternatively, the client system may be adapted to automatically determine the identity of the current user based upon one or more external signals such as, for example, an RFID tag or badge worn by the current user which provides a wireless signal to the client system for determining the identity of the current user. In at least one implementation, various security features may be incorporated into the client system to prevent unauthorized users from accessing confidential or sensitive information.
One or more display(s) 435. According to various embodiments, such display(s) may be implemented using, for example, LCD display technology, OLED display technology, and/or other types of conventional display technology. In at least one implementation, display(s) 435 may be adapted to be flexible or bendable. Additionally, in at least one embodiment the information displayed on display(s) 435 may utilize e-ink technology (such as that available from E Ink Corporation, Cambridge, Mass., www.eink.com), or other suitable technology for reducing the power consumption of information displayed on the display(s) 435.
One or more user I/O Device(s) 430 such as, for example, keys, buttons, scroll wheels, cursors, touchscreen sensors, audio command interfaces, magnetic strip reader, optical scanner, etc.
Audio/Video device(s) 439 such as, for example, components for displaying audio/visual media which, for example, may include cameras, speakers, microphones, media presentation components, wireless transmitter/receiver devices for enabling wireless audio and/or visual communication between the client system 400 and remote devices (e.g., radios, telephones, computer systems, etc.). For example, in one implementation, the audio system may include componentry for enabling the client system to function as a cell phone or two-way radio device.
Other types of peripheral devices 431 which may be useful to the users of various client systems, such as, for example: PDA functionality; memory card reader(s); fingerprint reader(s); image projection device(s); social networking peripheral component(s); etc.
Information filtering module(s) 449 which, for example, may be adapted to automatically and dynamically generate, using one or more filter parameters, filtered information to be displayed on one or more displays of the mobile device. In one implementation, such filter parameters may be customizable by the player or user of the device. In some embodiments, information filtering module(s) 449 may also be adapted to display, in real-time, filtered information to the user based upon a variety of criteria such as, for example, geolocation information, casino data information, player tracking information, etc.
Wireless communication module(s) 445. In one implementation, the wireless communication module 445 may be configured or designed to communicate with external devices using one or more wireless interfaces/protocols such as, for example, 802.11 (WiFi), 802.15 (including Bluetooth™), 802.16 (WiMax), 802.22, Cellular standards such as CDMA, CDMA2000, WCDMA, Radio Frequency (e.g., RFID), Infrared, Near Field Magnetics, etc.
Software/Hardware Authentication/validation components 444 which, for example, may be used for authenticating and/or validating local hardware and/or software components, hardware/software components residing at a remote device, game play information, wager information, user information and/or identity, etc. Examples of various authentication and/or validation components are described in U.S. Pat. No. 6,620,047, titled, “ELECTRONIC GAMING APPARATUS HAVING AUTHENTICATION DATA SETS,” incorporated herein by reference in its entirety for one or more purposes.
Operating mode selection component 448 which, for example, may be operable to automatically select an appropriate mode of operation based on various parameters and/or upon detection of specific events or conditions such as, for example: the mobile device's current location; identity of current user; user input; system override (e.g., emergency condition detected); proximity to other devices belonging to same group or association; proximity to specific objects, regions, zones, etc. Additionally, the mobile device may be operable to automatically update or switch its current operating mode to the selected mode of operation. The mobile device may also be adapted to automatically modify accessibility of user-accessible features and/or information in response to the updating of its current mode of operation.
Scanner/Camera Component(s) (e.g., 452) which may be configured or designed for use in scanning identifiers and/or other content from other devices and/or objects such as for example: mobile device displays, computer displays, static displays (e.g., printed on tangible mediums), etc.
OCR Processing Engine (e.g., 456) which, for example, may be operable to perform image processing and optical character recognition of images such as those captured by a mobile device camera, for example.
Speech Processing module (e.g., 454) which, for example, may be operable to perform speech recognition, and may be operable to perform speech-to-text conversion.
Accomplishment-Based Wagering Component(s) 494 which may be configured or designed to facilitate implementation and use of perceived skill gaming techniques for controlling game event influence and/or game outcomes in gaming environments. According to different embodiments, the Accomplishment-Based Wagering Component(s) may be configured or designed to include event influence/outcome functionality for facilitating implementation and use of perceived skill gaming techniques for controlling game event influence and/or game outcomes in gaming environments.
Etc.

According to a specific embodiment, the Mobile Device may be adapted to implement at least a portion of the features associated with the mobile game service system described in U.S. patent application Ser. No. 10/115,164, which is now U.S. Pat. No. 6,800,029, issued Oct. 5, 2004, (previously incorporated by reference in its entirety). For example. in one embodiment, the Mobile Device may be comprised of a hand-held game service user interface device (GSUID) and a number of input and output devices. The GSUID is generally comprised of a display screen which may display a number of game service interfaces. These game service interfaces are generated on the display screen by a microprocessor of some type within the GSUID. Examples of a hand-held GSUID which may accommodate the game service interfaces are manufactured by Symbol Technologies, Incorporated of Holtsville, N.Y.

The game service interfaces may be used to provide a variety of game service transactions and gaming operations services. The game service interfaces, including a login interface, an input/output interface, a transaction reconciliation interface, a ticket validation interface, a prize services interfaces, a food services interface, an accommodation services interfaces, a gaming operations interfaces, a multi-game/multi-denomination meter data transfer interface, etc. At least one interface may be accessed via a main menu with a number of sub-menus that allow a game service representative to access the different display screens relating to the particular interface. Using the different display screens within a particular interface, the game service representative may perform various operations needed to provide a particular game service. For example, the login interface may allow the game service representative to enter a user identification of some type and verify the user identification with a password. When the display screen is a touch screen, the user may enter the user/operator identification information on a display screen comprising the login interface using the input stylus and/or using the input buttons. Using a menu on the display screen of the login interface, the user may select other display screens relating to the login and registration process. For example, another display screen obtained via a menu on a display screen in the login interface may allow the GSUID to scan a finger print of the game service representative for identification purposes or scan the finger print of a game player.

The user identification information and user validation information may allow the game service representative to access one or more or some subset of the available game service interfaces available on the GSUID. For example, certain users, after logging into the GSUID (e.g. entering a user identification and a valid user identification information), may be able to access a variety of different interfaces, such as, for example, one or more of: input/output interface, communication interface, food services interface, accommodation services interface, prize service interface, gaming operation services interface, transaction reconciliation interface, voice communication interface, gaming device performance or metering data transfer interface, etc.; and perform a variety of services enabled by such interfaces. While other users may be only be able to access the award ticket validation interface and perform EZ pay ticket validations. The GSUID may also output game service transaction information to a number of different devices (e.g., card reader, printer, storage devices, gaming machines and remote transaction servers, etc.).

In addition to the features described above, various embodiments of mobile devices described herein may also include additional functionality for displaying, in real-time, filtered information to the user based upon a variety of criteria such as, for example, geolocation information, casino data information, player tracking information, etc.

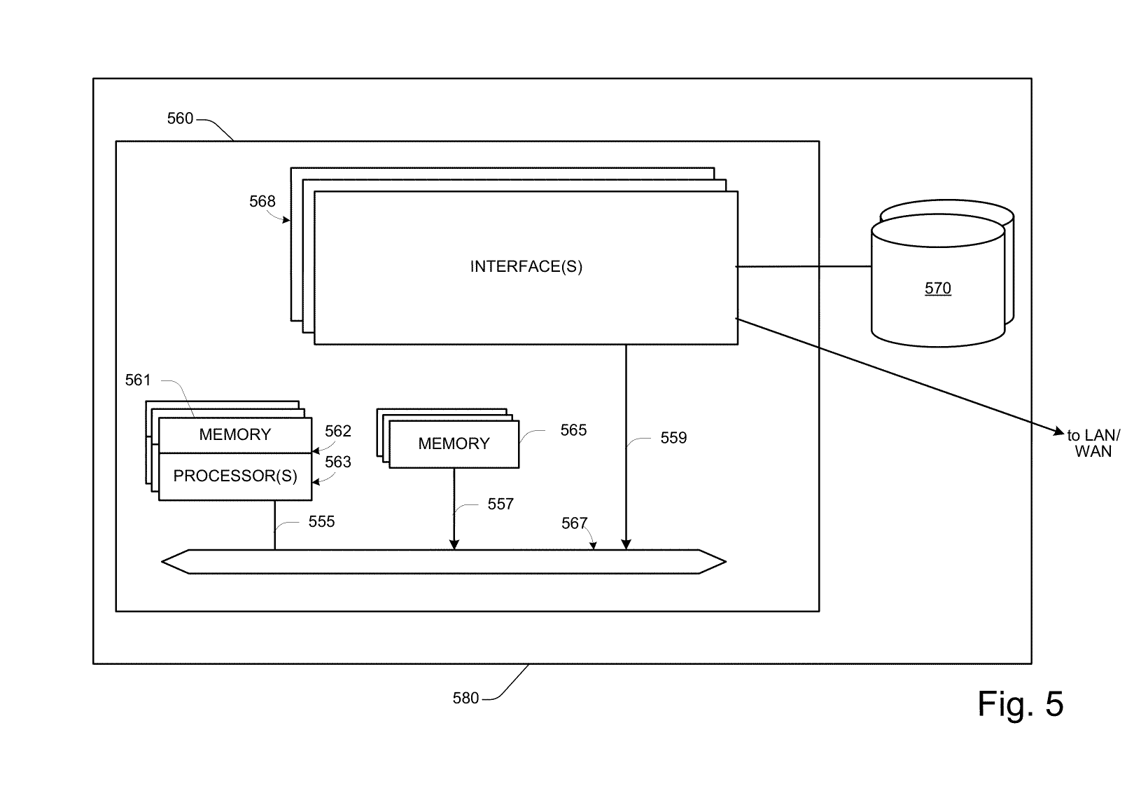

FIG. 5 illustrates an example embodiment of a Server System 580 which may be used for implementing various aspects/features described herein. In at least one embodiment, the Server System 580 includes at least one network device 560, and at least one storage device 570 (such as, for example, a direct attached storage device). In one embodiment, Server System 580 may be suitable for implementing at least some of the game event influence/outcome techniques described herein.

In according to one embodiment, network device 560 may include a master central processing unit (CPU) 562, interfaces 568, and a bus 567 (e.g., a PCI bus). When acting under the control of appropriate software or firmware, the CPU 562 may be responsible for implementing specific functions associated with the functions of a desired network device. For example, when configured as a server, the CPU 562 may be responsible for analyzing packets; encapsulating packets; forwarding packets to appropriate network devices; instantiating various types of virtual machines, virtual interfaces, virtual storage volumes, virtual appliances; etc. The CPU 562 preferably accomplishes at least a portion of these functions under the control of software including an operating system (e.g. Linux), and any appropriate system software (such as, for example, AppLogic™™ software).

CPU 562 may include one or more processors 563 such as, for example, one or more processors from the AMD, Motorola, Intel and/or MIPS families of microprocessors. In an alternative embodiment, processor 563 may be specially designed hardware for controlling the operations of Server System 580. In a specific embodiment, a memory 561 (such as non-volatile RAM and/or ROM) also forms part of CPU 562. However, there may be many different ways in which memory could be coupled to the system. Memory block 561 may be used for a variety of purposes such as, for example, caching and/or storing data, programming instructions, etc.

The interfaces 568 may be typically provided as interface cards (sometimes referred to as “line cards”). Alternatively, one or more of the interfaces 568 may be provided as on-board interface controllers built into the system motherboard. Generally, they control the sending and receiving of data packets over the network and sometimes support other peripherals used with the Server System 580. Among the interfaces that may be provided may be FC interfaces, Ethernet interfaces, frame relay interfaces, cable interfaces, DSL interfaces, token ring interfaces, Infiniband interfaces, and the like. In addition, various very high-speed interfaces may be provided, such as fast Ethernet interfaces, Gigabit Ethernet interfaces, ATM interfaces, HSSI interfaces, POS interfaces, FDDI interfaces, ASI interfaces, DHEI interfaces and the like. Other interfaces may include one or more wireless interfaces such as, for example, 802.11 (WiFi) interfaces, 802.15 interfaces (including Bluetooth™), 802.16 (WiMax) interfaces, 802.22 interfaces, Cellular standards such as CDMA interfaces, CDMA2000 interfaces, WCDMA interfaces, TDMA interfaces, Cellular 3G interfaces, etc.

Generally, one or more interfaces may include ports appropriate for communication with the appropriate media. In some cases, they may also include an independent processor and, in some instances, volatile RAM. The independent processors may control such communications intensive tasks as packet switching, media control and management. By providing separate processors for the communications intensive tasks, these interfaces allow the master microprocessor 562 to efficiently perform routing computations, network diagnostics, security functions, etc.

In at least one embodiment, some interfaces may be configured or designed to allow the Server System 580 to communicate with other network devices associated with various local area network (LANs) and/or wide area networks (WANs). Other interfaces may be configured or designed to allow network device 560 to communicate with one or more direct attached storage device(s) 570.

Although the system shown in FIG. 5 illustrates one specific network device described herein, it is by no means the only network device architecture on which one or more embodiments may be implemented. For example, an architecture having a single processor that handles communications as well as routing computations, etc. may be used. Further, other types of interfaces and media could also be used with the network device.

Regardless of network device's configuration, it may employ one or more memories or memory modules (such as, for example, memory block 565, which, for example, may include random access memory (RAM)) configured to store data, program instructions for the general-purpose network operations and/or other information relating to the functionality of the various game event influence/outcome techniques described herein. The program instructions may control the operation of an operating system and/or one or more applications, for example. The memory or memories may also be configured to store data structures, and/or other specific non-program information described herein.

Because such information and program instructions may be employed to implement the systems/methods described herein, one or more embodiments relates to machine readable media that include program instructions, state information, etc. for performing various operations described herein. Examples of machine-readable storage media include, but are not limited to, magnetic media such as hard disks, floppy disks, and magnetic tape; optical media such as CD-ROM disks; magneto-optical media such as floptical disks; and hardware devices that may be specially configured to store and perform program instructions, such as read-only memory devices (ROM) and random access memory (RAM). Some embodiments may also be embodied in transmission media such as, for example, a carrier wave travelling over an appropriate medium such as airwaves, optical lines, electric lines, etc. Examples of program instructions include both machine code, such as produced by a compiler, and files containing higher level code that may be executed by the computer using an interpreter.

FIG. 6 illustrates an example of a functional block diagram of a Server System 600 in accordance with a specific embodiment. In at least one embodiment, the Server System 600 may be operable to perform and/or implement various types of functions, operations, actions, and/or other features such, for example, one or more of those illustrated, described, and/or referenced herein.

In at least one embodiment, the Server System may include a plurality of components operable to perform and/or implement various types of functions, operations, actions, and/or other features such as, for example, one or more of the following (or combinations thereof):
Context Interpreter (e.g., 602) which, for example, may be operable to automatically and/or dynamically analyze contextual criteria relating to one or more detected event(s) and/or condition(s), and automatically determine or identify one or more contextually appropriate response(s) based on the contextual interpretation of the detected event(s)/condition(s). According to different embodiments, examples of contextual criteria which may be analyzed may include, but are not limited to, one or more of the following (or combinations thereof): location-based criteria (e.g., geolocation of client device, geolocation of agent device, etc.); time-based criteria; identity of Client user; identity of Agent user; user profile information; transaction history information; recent user activities; proximate business-related criteria (e.g., criteria which may be used to determine whether the client device is currently located at or near a recognized business establishment such as a bank, gas station, restaurant, supermarket, etc.); etc.
Time Synchronization Engine (e.g., 604) which, for example, may be operable to manages universal time synchronization (e.g., via NTP and/or GPS)
Search Engine (e.g., 628) which, for example, may be operable to search for transactions, logs, items, accounts, options in the TIS databases
Configuration Engine (e.g., 632) which, for example, may be operable to determine and handle configuration of various customized configuration parameters for one or more devices, component(s), system(s), process(es), etc.
Time Interpreter (e.g., 618) which, for example, may be operable to automatically and/or dynamically modify or change identifier activation and expiration time(s) based on various criteria such as, for example, time, location, transaction status, etc.
Authentication/Validation Component(s) (e.g., 647) (password, software/hardware info, SSL certificates) which, for example, may be operable to perform various types of authentication/validation tasks such as, for example, one or more of the following (or combinations thereof): verifying/authenticating devices; verifying passwords, passcodes, SSL certificates, biometric identification information, and/or other types of security-related information; verify/validate activation and/or expiration times; etc. In one implementation, the Authentication/Validation Component(s) may be adapted to determine and/or authenticate the identity of the current user or owner of the mobile client system. For example, in one embodiment, the current user may be required to perform a log in process at the mobile client system in order to access one or more features. In some embodiments, the mobile client system may include biometric security components which may be operable to validate and/or authenticate the identity of a user by reading or scanning The user's biometric information (e.g., fingerprints, face, voice, eye/iris, etc.). In at least one implementation, various security features may be incorporated into the mobile client system to prevent unauthorized users from accessing confidential or sensitive information.
Transaction Processing Engine (e.g., 622) which, for example, may be operable to handle various types of transaction processing tasks such as, for example, one or more of the following (or combinations thereof): identifying/determining transaction type; determining which payment gateway(s) to use; associating databases information to identifiers; etc.
OCR Processing Engine (e.g., 634) which, for example, may be operable to perform image processing and optical character recognition of images such as those captured by a mobile device camera, for example.
Wager Tracking/Accounting Component(s) 614
Game Server(s) & Game State Tracking Component(s) 615
Database Manager (e.g., 626) which, for example, may be operable to handle various types of tasks relating to database updating, database management, database access, etc. In at least one embodiment, the Database Manager may be operable to manage TISS databases, Gaming Device Application databases, etc.
Log Component(s) (e.g., 610) which, for example, may be operable to generate and manage transactions history logs, system errors, connections from APIs, etc.
Status Tracking Component(s) (e.g., 612) which, for example, may be operable to automatically and/or dynamically determine, assign, and/or report updated transaction status information based, for example, on the state of the transaction. In at least one embodiment, the status of a given transaction may be reported as one or more of the following (or combinations thereof): Completed, Incomplete, Pending, Invalid, Error, Declined, Accepted, etc.
Gateway Component(s) (e.g., 614) which, for example, may be operable to facilitate and manage communications and transactions with external Payment Gateways.
Web Interface Component(s) (e.g., 608) which, for example, may be operable to facilitate and manage communications and transactions with TIS web portal(s).
API Interface(s) to Server System(s) (e.g., 646) which, for example, may be operable to facilitate and manage communications and transactions with API Interface(s) to Server System(s)
API Interface(s) to 3rd Party Server System(s) (e.g., 648) which, for example, may be operable to facilitate and manage communications and transactions with API Interface(s) to 3rd Party Server System(s)
OCR Processing Engine (e.g., 634) which, for example, may be operable to perform image processing and optical character recognition of images such as those captured by a mobile device camera, for example.
At least one processor 610. In at least one embodiment, the processor(s) 610 may include one or more commonly known CPUs which are deployed in many of today's consumer electronic devices, such as, for example, CPUs or processors from the Motorola or Intel family of microprocessors, etc. In an alternative embodiment, at least one processor may be specially designed hardware for controlling the operations of the mobile client system. In a specific embodiment, a memory (such as non-volatile RAM and/or ROM) also forms part of CPU. When acting under the control of appropriate software or firmware, the CPU may be responsible for implementing specific functions associated with the functions of a desired network device. The CPU preferably accomplishes one or more these functions under the control of software including an operating system, and any appropriate applications software.
Memory 616, which, for example, may include volatile memory (e.g., RAM), non-volatile memory (e.g., disk memory, FLASH memory, EPROMs, etc.), unalterable memory, and/or other types of memory. In at least one implementation, the memory 616 may include functionality similar to at least a portion of functionality implemented by one or more commonly known memory devices such as those described herein and/or generally known to one having ordinary skill in the art. According to different embodiments, one or more memories or memory modules (e.g., memory blocks) may be configured or designed to store data, program instructions for the functional operations of the mobile client system and/or other information relating to the functionality of the various Mobile Transaction techniques described herein. The program instructions may control the operation of an operating system and/or one or more applications, for example. The memory or memories may also be configured to store data structures, metadata, identifier information/images, and/or information/data relating to other features/functions described herein. Because such information and program instructions may be employed to implement at least a portion of the Gaming Network techniques described herein, various aspects described herein may be implemented using machine readable media that include program instructions, state information, etc. Examples of machine-readable media include, but are not limited to, magnetic media such as hard disks, floppy disks, and magnetic tape; optical media such as CD-ROM disks; magneto-optical media such as floptical disks; and hardware devices that are specially configured to store and perform program instructions, such as read-only memory devices (ROM) and random access memory (RAM). Examples of program instructions include both machine code, such as produced by a compiler, and files containing higher level code that may be executed by the computer using an interpreter.
Interface(s) 606 which, for example, may include wired interfaces and/or wireless interfaces. In at least one implementation, the interface(s) 606 may include functionality similar to at least a portion of functionality implemented by one or more computer system interfaces such as those described herein and/or generally known to one having ordinary skill in the art.
Device driver(s) 642. In at least one implementation, the device driver(s) 642 may include functionality similar to at least a portion of functionality implemented by one or more computer system driver devices such as those described herein and/or generally known to one having ordinary skill in the art.
One or more display(s) 635. According to various embodiments, such display(s) may be implemented using, for example, LCD display technology, OLED display technology, and/or other types of conventional display technology. In at least one implementation, display(s) 635 may be adapted to be flexible or bendable. Additionally, in at least one embodiment the information displayed on display(s) 635 may utilize e-ink technology (such as that available from E Ink Corporation, Cambridge, Mass., www.eink.com), or other suitable technology for reducing the power consumption of information displayed on the display(s) 635.
Email Server Component(s) 636, which, for example, may be configured or designed to provide various functions and operations relating to email activities and communications.
Web Server Component(s) 637, which, for example, may be configured or designed to provide various functions and operations relating to web server activities and communications.
Messaging Server Component(s) 638, which, for example, may be configured or designed to provide various functions and operations relating to text messaging and/or other social network messaging activities and/or communications.
Accomplishment-Based Wagering Component(s) 694 which may be configured or designed to facilitate implementation and use of perceived skill gaming techniques for controlling game event influence and/or game outcomes in gaming environments. According to different embodiments, the Accomplishment-Based Wagering Component(s) may be configured or designed to include event influence/outcome functionality for facilitating implementation and use of perceived skill gaming techniques for controlling game event influence and/or game outcomes in gaming environments.

In at least one embodiment, a gaming network may provide capability to allow players and/or non-players (collectively “Wagerer(s)”) to make side wagers on games (and/or game-related events) played by other players. For example, in one embodiment, a Wagerer of the gaming network may be allowed to search for other active players, and may be allowed to browse and/or select various types of events and/or activities for placing side wagers.

In at least one embodiment, wagers may be asynchronously placed and queued up in advance. For example, in one embodiment, the Wagerer may identify and/or select (e.g., in advance) a plurality of different Challenges (e.g., yet to be played) for placing wagers. The Wagerer may then specify individual wager amounts for each of the identified Challenges.

One embodiment may utilize a distributed messaging service to provide game details to players, challengers and/or wagerers. In one embodiment, the messaging service may include a message bus where selected (or all) game related events, wagers, challenges and/or messages are posted. In one embodiment, messages posted to the message bus may include details that link the messages to a particular person, gaming device, gaming session, etc. such that messages may be identified and filtered for use by a wager management system server. In one embodiment, a wager management system and/or event notification system may be operable provide the message bus functionality and/or event notification/subscription functionality for Wagerers.

In one embodiment, a Wagerer who places a wager on a particular Accomplishment-Based Wagering outcome or event (e.g., associated with a given wager-related activity) may subscribe to receive messages from the message bus which relate to gaming and/or wagering activities associated with the wager-related activity. In one embodiment, the subscription service may be operable to filter messages from the bus based on various criteria and/or parameters. In this way messages may be filtered such that a Wagerer is able to monitor and/or receive event notification messages which relate to the wager(s) placed by the Wagerer. In addition, the wager management system may be operable to provide encryption and/or authentication to ensure that only authorized clients are allowed to have access to appropriate wager related information.

In at least one embodiment, the wager management system and/or event notification system may be configured or designed in a manner which allows wagering to be decoupled from regular game play and/or in a manner which is transparent to game developers. For example, in at least one embodiment, game developer's don't need any foreknowledge of how wagering is implemented. In one embodiment, the games may be designed to simply post game moves and results to the message bus, and the wager management system and/or event notification system server(s) take care of the rest.

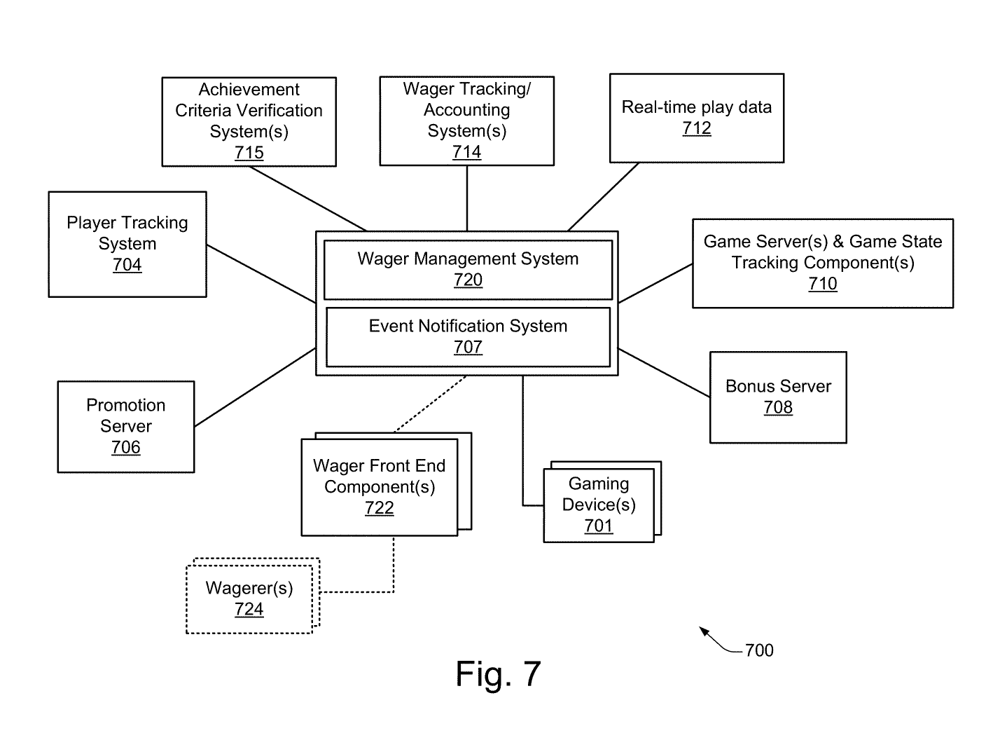

FIG. 7 shows a specific example of an embodiment of an accomplishment-based wagering network 700 which may be used for implementing various features. Descriptions of at least a portion of the various components and/or systems shown in FIG. 7 are also provided in other sections of this application.

As illustrated in the example of FIG. 7, accomplishment-based wagering network 700 may include one or more electronic Gaming Devices (EGDs) 701 for which accomplishment-based wagering functionality has been enabled. Depending upon particular circumstances, a player may or may not be actively involved in game play at one of the Gaming Device(s).

One or more Wagerers 724 (which, for example, may include initiators, challengers, Challenge participants, and/or other entities) may desire to engage in accomplishment-based wagering activity. In one embodiment, a Wagerer 724 may communicate with one or more Wager Front End System(s) 722 for conducting wager related activity. According to different embodiments, different Wager Front End Systems 722 may be implemented via, for example, one or more of the following (or combinations thereof): an electronic gaming device, a kiosk, a PDA (or other mobile or handheld device), a smart phone, a computer system, a server system, an interactive gaming console display/interface, etc. In at least one embodiment, the Wager Front End System device may be operable to facilitate accomplishment-based wager activities conducted by one or more Wagerers, and may further be operable to facilitate communication between the Wagerer(s) 724, the Wager Management System 720, Event Notification System 707 and/or other systems/components of the accomplishment-based wagering network.

As illustrated in the embodiment of FIG. 7, accomplishment-based wagering network 700 includes a Wager Management System 720 which is operable to facilitate and/or manage a variety of accomplishment-based wagering activities and/or related information which is conducted in accomplishment-based wagering network 700. According to some embodiments, such as that illustrated in FIG. 7, the Wager Management System 720 may be operable to communicate with various other components and/or systems of accomplishment-based wagering network 700 in order, for example, to carry out operations relating to its various functionalities. As illustrated in the embodiment of FIG. 7, such other components and/or systems may include, but are not necessarily limited to, one or more of the following: promotion server(s) 706, player tracking system(s) 704, casino layout/physical environment system(s), wager tracking/accounting system(s) 714 (which, for example, may include Wager Escrow components), real-time data tracking system(s) 712, game server(s) 710, game state tracking component(s) 710, bonus server(s) 708, event notification system 707, EGDs 701, Achievement Criteria Verification System(s) 715, etc. In at least one embodiment, the Achievement Criteria Verification System(s) 715 may be configured or designed to acquire statistical or factual data from trusted external sources, and may further be configured or designed to determine and/or verify whether or not the achievement criteria associated with a given accomplishment-based wagering Challenge has been successfully satisfied or accomplished by one or more of the Challenge participants.

In at least one embodiment, event notification system 707 may include one or more event notification servers for providing event notification functionality to various entities (e.g., devices, systems, persons, etc.) of the accomplishment-based wagering network. For example, in at least one embodiment, various devices/systems of the accomplishment-based wagering network may provide periodic event notification updates to the event notification system 707. For example, in one embodiment, selected EGDs 701 and/or selected gaming console systems 703 may provide periodic updates to the event notification system relating to their respective current status/states of game play activity, accomplishment-based wagering activity, player activity, etc. Additionally, various other devices/systems of the accomplishment-based wagering network, such as, for example, one or more Wager Front End System devices may subscribe to receive periodic alerts and/or notifications from the event notification system regarding updated event information relating to changes in status/states of game play activity, accomplishment-based wagering activity, player activity, etc. for selected EGDs 701.

In at least one embodiment, event notification system 707 may be operable to perform one or more of the following functions (or combinations thereof):
track changes in game play states/status relating to one or more EGDs;
track changes in accomplishment-based wagering activities occurring at one or more EGDs;
track changes in player activities occurring at one or more EGDs;
track changes in game play states/status for games relating to one or more players;
provide subscription-based event notification service to various systems/devices of the accomplishment-based wagering network;
manage event notification subscriptions;
generate event notification messages relating to different types of events which are tracked by the event notification system;
forward selected event notification messages to appropriate subscribing entities of the accomplishment-based wagering network;
etc.

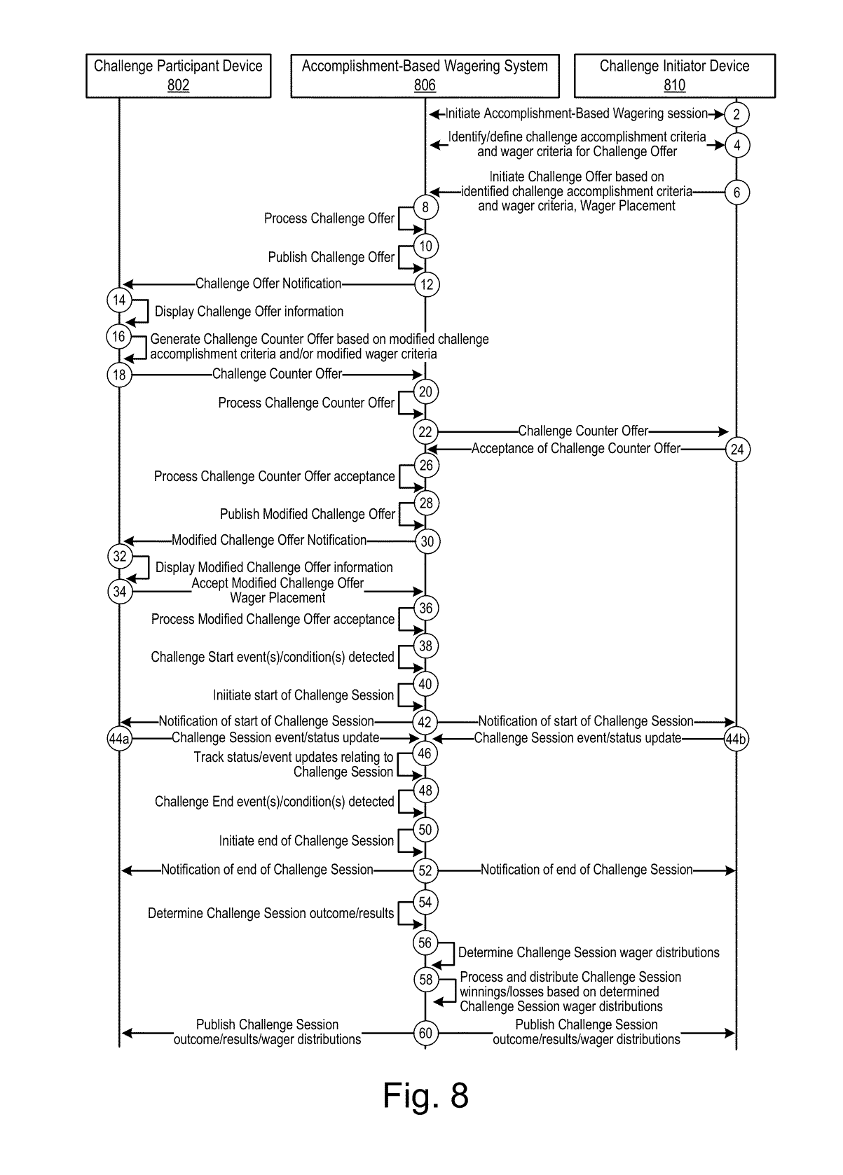

FIG. 8 shows a specific embodiment of an example data flow diagram illustrating various action between various devices/systems of a gaming network. According to different embodiments, at least a portion of the various actions/operations illustrated in FIG. 8 may be implemented in real-time or substantially real-time.

According to various embodiments, various portions of the activities described with respect to FIG. 8 may be implemented via one or more gaming network components and/or systems described herein such as, for example, one or more of the following (or combinations thereof): one or more Challenge Participant Device(s) 802, Accomplishment-Based Wagering System 806, one or more Challenge Initiator Device(s) 810, etc.

In the example embodiment of FIG. 8, it is assumed that a first entity (e.g., an individual, a company, etc.) wishes to initiate an accomplishment-based wagering challenge. Accordingly, for reference purposes in this particular example, this first entity (e.g., wishing to initiate a specific accomplishment-based wagering Challenge) will be referred to as the “Challenge Initiator”. Additionally, for reference purposes, each of the entities who participate in the Challenge may be referred to as a “Challenge Participant.” For purposes of clarity and ease of illustration, it is assumed in the example embodiment of FIG. 8 that an individual Challenge Initiator has initiated an accomplishment-based wagering Challenge which is being participated in by a single Challenge Participant. However, it will be appreciated that in alternate example embodiments, multiple Challenge Participants may be allowed to participate in the accomplishment-based wagering Challenge.

In the example embodiment of FIG. 8, it is assumed at (2) that the Challenge Initiator accesses his or her Challenge Initiator Device 810 in order to initiate an offer of an accomplishment-based wagering Challenge. In at least one embodiment, the Challenge Initiator Device 810 may include functionality for facilitating or enabling the Challenge Initiator to initiate an offer of an accomplishment-based wagering Challenge. In other embodiments, as illustrated in the example embodiment of FIG. 8, the Challenge Initiator Device 810 may communicate with the Accomplishment-Based Wagering System 806 in order to facilitate or enable the Challenge Initiator to initiate an offer of an accomplishment-based wagering Challenge.

As shown at (4), it is assumed that the challenge initiator selects, identifies, determines, and/or otherwise defines a first set of Challenge accomplishment criteria and wager criteria relating to the accomplishment-based wagering Challenge to be offered. According to different embodiments, the Challenge Initiator may be provided with the ability to select the amount and/or type of wager, and to define, identify and/or otherwise select the accomplishment criteria/parameters to be associated with the accomplishment-based wagering Challenge. For example, in at least some embodiments, the accomplishment-based wagering system may be configured or designed to enable the Challenge Initiator to define desired wagering parameters and/or accomplishment criteria by selecting from a list of parameters/criteria (e.g., provided by an accomplishment-based wagering system server), and/or by establishing or defining their own unique wager and achievement parameters/criteria in an ad-hoc fashion.

In at least one embodiment, it is preferable that the set of achievement parameters which are identified or defined by the Challenge Initiator be based on objective criteria which can be used to unambiguously confirm or verify (e.g., by an automated Accomplishment criteria Verification System) whether or not the set of achievement parameters has been successfully satisfied or accomplished at the end of the accomplishment-based wagering Challenge session.

At (6) it is assumed that the Challenge Initiator initiates a Challenge Offer based on the set of challenge accomplishment criteria and wager criteria selected/identified by the Challenge Initiator. In at least one embodiment, in order to initiate and publish the Challenge Offer, the Challenge Initiator may also be required to provide sufficient monetary resources (e.g., cash, credit, etc.) for funding the wager amount(s) which are associated with the Challenge Offer.

In at least one embodiment, the Challenge Offer request submitted to the Accomplishment-Based Wagering System may include various types of information such as, for example, one or more of the following (or combinations thereof):
Authentication information.
Information relating to the identity of the Challenge Initiator.
Player tracking information relating to the Challenge Initiator.
Player rating information relating to the Challenge Initiator.
Player profile information relating to the Challenge Initiator.
Information relating to the Challenge Initiator's geolocation.
Information relating to the gaming device(s).
Information relating to an identity of one or more potential Challenge Participants.
Social network information relating to the Challenge Initiator's social networks.
Contact information relating to the Challenge Initiator's social friends.

In at least one embodiment, the Accomplishment-Based Wagering System may coordinate escrowing of the wager-related funds provided by the Challenge Initiator, whereby, for example, the wager-related funds provided by the Challenge Initiator are held in a type of “escrow” during the Challenge session, and are automatically distributed at the end of the Challenge session based on the Challenge session's outcome/results.

At (8), it is assumed that the Accomplishment-Based Wagering System processes the Challenge Offer and associated achievement and wager criteria. In at least one embodiment, the processing of the Challenge Offer may include facilitating, enabling, initiating, and/or performing one or more of the following operation(s), action(s), and/or feature(s) (or combinations thereof)
verifying compliance of the Challenge Offer's achievement and/or wager criteria to ensure that it is in compliance with selected rules, regulations, and/or restrictions;
verifying that the Challenge Initiator not prohibited from initiating the Challenge Offer;
verifying that the Challenge Initiator has provided sufficient monetary or fungible resources (e.g., cash, credit, etc.) for funding and covering the wager amount(s) which are associated with the Challenge Offer;
etc.

Assuming that the Challenge Offer is approved, the accomplishment-based wagering Challenge may publish (10) the Challenge Offer.

At (12), it is assumed that notification of the Challenge Offer is provided to Challenge Participant Device 802, whereupon information relating to the Challenge Offer may be displayed (14) or presented (e.g., via the Challenge Participant Device) to one or more challengers or potential Challenge Participants. In at least one embodiment, the Accomplishment-Based Wagering System may distribute information relating to the Challenge Offer to selected players, challengers, gaming devices, systems, components, etc.

In other embodiments (not shown), information relating to the Challenge Offer multiple different challengers on multiple different gaming devices may each separately, individually, and asynchronously accept (or reject, or counter) the Challenge Offer, place their own respective wagers, and participate in the Challenge session. In some embodiments, a separate Challenge session may be initiated for each respective Challenge Participant who is participating in the Challenge Offer. In some embodiments, each different Challenge session associated with a given Challenge Offer may be configured to be asynchronous with the other Challenge session associated with that Challenge Offer. Further, in at least some embodiments, multiple challenge participants may actively and asynchronously participate in a given Challenge Offer.

For purposes of illustration, in the example embodiment of FIG. 8, it is assumed that a user of the Challenge Participant Device initiates a Challenge Counter Offer which specifies a modified set of challenge accomplishment criteria and/or modified wager criteria. An example sequence of activities relating to the Challenge Counter Offer are illustrated in FIG. 8 by activities 16-32, and are described in greater detail below. However, it will be appreciated that, in alternate embodiments, the user associated with Challenge Participant Device 810 may elect to accept the initial Challenge Offer (e.g., presented at 14) without initiating or submitting a Challenge Counter Offer.

At (18), it is assumed that the Challenge Participant selects, identifies, determines, and/or otherwise defines a modified set of Challenge accomplishment criteria and/or wager criteria relating to the Challenge Counter Offer. In at least one embodiment, the Challenge Participant may create the Challenge Counter Offer using one or more techniques similar to those described with respect to the creating of a Challenge Offer.

At (20) the Accomplishment-Based Wagering System may process the Challenge Counter Offer. In at least one embodiment, the processing of the Challenge Counter Offer may include collecting wager-related funds from the entity initiating the Challenge Counter Offer.

At (22), information relating to the Challenge Counter Offer may be presented to the Challenge Initiator. In at least one embodiment, the Challenge Initiator may elect to perform one of the following actions in response to the Challenge Counter Offer: (i) accept the Challenge Counter Offer, (ii) decline the Challenge Counter Offer, (iii) propose an alternate Challenge Counter Offer. In the example embodiment of FIG. 8, it is assumed that the Challenge Initiator elect to accept (24) the Challenge Counter Offer.

In at least one embodiment, depending upon the terms of the modified achievement and wager criteria associated with the Challenge Counter Offer, the Challenge Initiator may be required to provide additional funds to satisfy the wager-related terms/conditions specified by the Challenge Counter Offer.

At (26), the Accomplishment-Based Wagering System may process the Challenge Initiator's acceptance of the Challenge Counter Offer. In the example embodiment of FIG. 8, the acceptance of the Challenge Counter Offer by the Challenge Initiator is effectively treated as a modification of the terms of the Challenge Initiator's original Challenge Offer.

In at least one embodiment, the processing of the acceptance of Challenge Counter Offer may include activities such as, for example: collecting and escrowing additional wager funds from the Challenge Initiator; refunding or returning a portion of previously collected wager funds back to the Challenge Initiator; publishing (28) the updated or modified terms of the modified Challenge Offer; providing notification (30) of the modified terms of the Challenge Offer to one or more entities or devices (e.g., Challenge Participant Device 802), etc.

At (32), the Challenge Offer may be displayed or presented to the potential Challenge Participant via the Challenge Participant Device 802.

At (34) it is assumed that the Challenge Participant accepts the modified Challenge Offer, and provides wager funds, as needed, in accordance with the wager-related terms of the modified Challenge Offer. In at least some embodiments (such as, for example, the previously described example embodiment the Accomplishment-Based Wager System (ABWS) for Corporate/Marketing Promotions) the Challenge Participant may not be required to advance any funds or place any wagers in order to participate in the Challenge Offer.

In at least one embodiment, the Challenge Acceptance request submitted to the Accomplishment-Based Wagering System may include various types of information such as, for example, one or more of the following (or combinations thereof):
Authentication information.
Information relating to the identity of the Challenge Participant.
Player tracking information relating to the Challenge Participant.
Player rating information relating to the Challenge Participant.
Player profile information relating to the Challenge Participant.
Information relating to the Challenge Participant's geolocation.
Information relating to the gaming device(s).
Information relating to an identity of one or more potential Challenge Participants.
Social network information relating to the Challenge Participant's social networks.
Contact information relating to the Challenge Participant's social friends.

At (36) the Accomplishment-Based Wagering System processes the Challenge Participant's acceptance of the modified Challenge Offer. In at least one embodiment, the processing of the Challenge Participant's acceptance of the modified Challenge Offer may include activities such as, for example: collecting and escrowing additional wager funds from the Challenge Participant; refunding or returning a portion of previously collected wager funds back to the Challenge Participant; publishing the Challenge Participant's acceptance of the modified Challenge Offer; providing notification of the Challenge Participant's acceptance of the modified Challenge Offer to one or more entities or devices (e.g., Challenge initiator Device 810), etc.

In at least one embodiment, the “open enrollment” period of a Challenge Offer (e.g., the time window in which Wagerers are allowed to accept participation in the Challenge Offer) may be specified by one or more of the terms, conditions and/or other criteria defined in the Challenge Offer. Similarly, the start or commencement of a Challenge session and the duration of the Challenge session (e.g., the period of time during which the Challenge Participants may actively participate in the Challenge Offer) may also be specified by other terms, conditions and/or other criteria defined in the Challenge Offer. Additionally, the closing or ending of a Challenge session may also be specified by other terms, conditions and/or other criteria defined in the Challenge Offer. Examples of such terms, conditions and/or other criteria may include, but are not limited to, one or more of the following (or combinations thereof):
time-based criteria (e.g., duration of open enrollment period is 36 hours from date that challenge offer is published; open enrollment period closes at 12 am on Jan. 1, 2014; duration of Challenge session is 24 hours; Challenge session ends at 12 am on Jan. 1, 2014 etc.);
event-based criteria (e.g., open enrollment period closes upon the successful acceptance of the Challenge Offer by a Challenge Participant; open enrollment period closes once 15 Challenge Participants have accepted the Challenge Offer; open enrollment period closes upon the initial kickoff of the 2014 NFL Superbowl Game; start of Challenge session begins after the initial kickoff of the 2014 NFL Superbowl Game; start of Challenge session begins upon the successful acceptance of the Challenge Offer by a Challenge Participant; start of Challenge session begins after 15 Challenge Participants have accepted the Challenge Offer; Challenge session closes after the Challenge Participant has made three unsuccessful attempts to satisfy the accomplishment criteria of the Challenge Offer; Challenge session closes after one of the Challenge Participant successfully completes all of the accomplishment criteria of the Challenge Offer; etc.);
quota-based criteria (e.g., open enrollment period closes after at least one male and at least one female have accepted the Challenge Offer; Challenge session begins after at least one male and at least one female have accepted the Challenge Offer);
location-based criteria (e.g., Challenge session remains active as long as the Challenge Participant is located within the state of Nevada; Challenge session closes upon detecting that the Challenge Participant is located at an elevation above 5000 feet);
and/or other types of conditions and/or criteria, as may be desired or specified by the Challenge Initiator, Accomplishment-Based Wagering System and/or regulatory entities.

In some embodiments, the open enrollment period of a Challenge Offer does not close, even after the start of the Challenge session has commenced. In such embodiments, Challenge Participant may be allowed to “jump in” and participate in a given Challenge, even after the Challenge session has started. In other embodiments, a given Challenge Offer may have associated therewith multiple different Challenge sessions. In some embodiments, some of the multiple Challenge sessions may occur serially or sequentially. In other embodiments, some of the multiple Challenge sessions may take place concurrently. In yet other embodiments, the duration of a Challenge session may be different for different Challenge Participants who are participating in the Challenge Offer. For example, in one embodiment, a Challenge Offer may allow for multiple Challenge Participants, and the Challenge session for a given Challenge Participant may be caused to be closed after that Challenge Participant has made three unsuccessful attempts to satisfy the accomplishment criteria of the Challenge Offer.

Returning to the example embodiment of FIG. 8, it is assumed that the Accomplishment-Based Wagering System determines (e.g., from the terms, conditions and criteria of the modified Challenge Offer) the open enrollment period, Challenge session start, Challenge session duration, and/or Challenge session end parameters for the modified Challenge Offer.

In the example embodiment of FIG. 8, it is assumed that the open enrollment period for the modified Challenge Offer closes after the Challenge Participant has accepted the modified Challenge Offer. Accordingly, the Accomplishment-Based Wagering System may initiate (40) the start of a Challenge session (for the modified Challenge Offer) upon detecting (38) the occurrence of the appropriate event(s)/condition(s)/criteria (e.g., “Challenge Start” criteria) for triggering the start of the Challenge session. The Accomplishment-Based Wagering System may provide notification (42) of the start of the Challenge session to the Challenge Participant(s) and Challenge Initiator. In one embodiment, the Accomplishment-Based Wagering System may also provide instructions to Challenge Participant Device 802 to initiate an accomplishment-based wagering Challenge gaming session at the Challenge Participant Device 802.

According to different embodiments, status updates and activities relating to the Challenge session may be automatically monitored and tracked (46) by the Accomplishment-Based Wagering System. Additionally, in some embodiments, status updates and activities relating to the Challenge session may be reported (44a, 44b) by the Challenge Participant(s) and/or Challenge Initiator.

At (48), it is assumed that the Accomplishment-Based Wagering System has detected the occurrence of the appropriate event(s)/condition(s)/criteria (e.g., “Challenge End” criteria) for triggering the end of the Challenge session. Accordingly, the Accomplishment-Based Wagering System may initiate (50) the end of the Challenge session, and may provide notification (52) of the end of the Challenge session to the Challenge Participant(s) and Challenge Initiator.

According to different embodiments, the Accomplishment-Based Wagering System may publish events and/or may distribute automated notifications relating to one or more of the following (or combinations thereof):
the posting of a new Challenge Offer;
the updating or modifying of a Challenge Offer;
the acceptance of a Challenge Offer by one or more Challenge Participant;
the opening of an enrollment period for a given Challenge Offer;
the closing of an enrollment period for a given Challenge Offer;
the starting of an active Challenge session (“Challenge Session”) relating to a given Challenge Offer;
the ending of an active Challenge session (“Challenge Session”) relating to a given Challenge Offer;
status updates relating to Challenge Participant activities and/or rankings, Challenge session event(s), changes to one or more states of the Challenge session, etc.
final results or outcomes associated with a given Challenge Offer or Challenge session
updated leaderboard information
etc.

In at least one embodiment, the Accomplishment-Based Wagering System may include functionality for automatically and/or dynamically determining (54) the final outcome and/or results for a given Challenge session which has ended. In some embodiments, at least a portion of this functionality may be provided by the Accomplishment criteria Verification System(s) (e.g., 715, FIG. 7) which, for example, may be configured or designed to acquire statistical or factual data from trusted external sources, and may further be configured or designed to determine and/or verify whether or not the accomplishment criteria associated with a given accomplishment-based wagering Challenge has been successfully satisfied or accomplished by one or more of the Challenge Participants.

Additionally, the Accomplishment-Based Wagering System may also include functionality for automatically and/or dynamically determining (56) the appropriate wager distributions for a given Challenge session which has ended. In at least one embodiment, the determination of the wager distributions for a given Challenge session may be based on the wager-related criteria of the associated Challenge Offer, as well as the final outcome/results of the Challenge session.

At (58), the Accomplishment-Based Wagering System may process and distribute Challenge Session winnings/losses to the Challenge Participant(s) and/or Challenge Initiator, in accordance with determined Challenge Session wager distributions. For example, in at least one embodiment, the Accomplishment-Based Wagering System may be configured or designed to determine winnings and/or losses relating to the Challenge session results, and initiates and/or facilitate settlement of settle the Challenge session related wager(s).

At (60) the Accomplishment-Based Wagering System may publish and/or provide notification of the Challenge Session outcome/results/wager distributions to the Challenge Participant(s) and Challenge Initiator.

According to different embodiments, at least a portion of the various types of functions, operations, actions, and/or other features provided by the accomplishment-based wagering procedures described and/or referenced herein may be implemented at one or more client systems(s), at one or more server systems (s), and/or combinations thereof.

In at least one embodiment, one or more of the accomplishment-based wagering procedures may be operable to utilize and/or generate various different types of data and/or other types of information when performing specific tasks and/or operations. This may include, for example, input data/information and/or output data/information. For example, in at least one embodiment, the accomplishment-based wagering procedures may be operable to access, process, and/or otherwise utilize information from one or more different types of sources, such as, for example, one or more local and/or remote memories, devices and/or systems. Additionally, in at least one embodiment, the accomplishment-based wagering procedures may be operable to generate one or more different types of output data/information, which, for example, may be stored in memory of one or more local and/or remote devices and/or systems. Examples of different types of input data/information and/or output data/information which may be accessed and/or utilized by the accomplishment-based wagering procedures may include, but are not limited to, one or more of those described and/or referenced herein.

In at least one embodiment, a given instance of the accomplishment-based wagering procedures may access and/or utilize information from one or more associated databases. In at least one embodiment, at least a portion of the database information may be accessed via communication with one or more local and/or remote memory devices. Examples of different types of data which may be accessed by the accomplishment-based wagering procedures may include, but are not limited to, one or more of those described and/or referenced herein.

According to specific embodiments, multiple instances or threads of the accomplishment-based wagering procedures may be concurrently implemented and/or initiated via the use of one or more processors and/or other combinations of hardware and/or hardware and software. For example, in at least some embodiments, various aspects, features, and/or functionalities of the accomplishment-based wagering procedures may be performed, implemented and/or initiated by one or more of the various systems, components, systems, devices, procedures, processes, etc., described and/or referenced herein.

According to different embodiments, one or more different threads or instances of the accomplishment-based wagering procedures may be initiated in response to detection of one or more conditions or events satisfying one or more different types of minimum threshold criteria for triggering initiation of at least one instance of the accomplishment-based wagering procedures. Various examples of conditions or events which may trigger initiation and/or implementation of one or more different threads or instances of the accomplishment-based wagering procedures may include, but are not limited to, one or more of those described and/or referenced herein.

According to different embodiments, one or more different threads or instances of the accomplishment-based wagering procedures may be initiated and/or implemented manually, automatically, statically, dynamically, concurrently, and/or combinations thereof. Additionally, different instances and/or embodiments of the accomplishment-based wagering procedures may be initiated at one or more different time intervals (e.g., during a specific time interval, at regular periodic intervals, at irregular periodic intervals, upon demand, etc.).

In at least one embodiment, initial configuration of a given instance of the accomplishment-based wagering procedures may be performed using one or more different types of initialization parameters. In at least one embodiment, at least a portion of the initialization parameters may be accessed via communication with one or more local and/or remote memory devices. In at least one embodiment, at least a portion of the initialization parameters provided to an instance of the accomplishment-based wagering procedures may correspond to and/or may be derived from the input data/information.

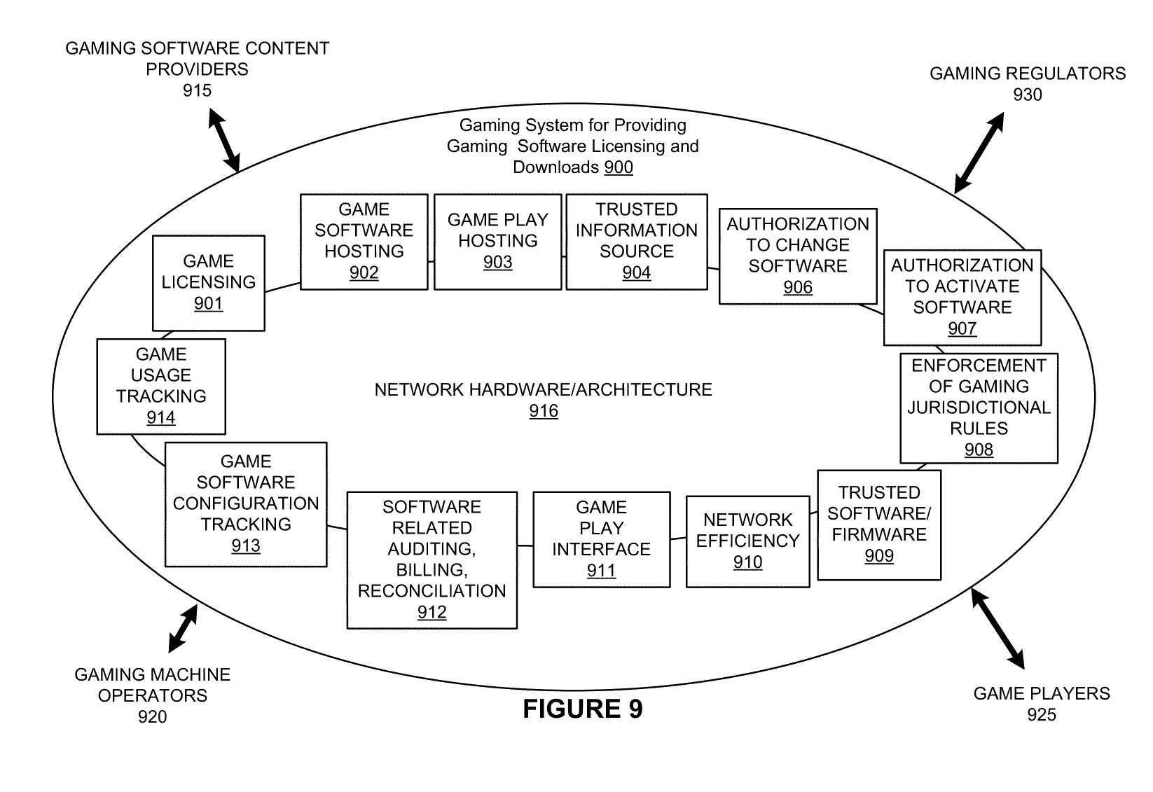

FIG. 9 shows a block diagram illustrating components of a gaming network 900 which may be used for implementing various aspects of example embodiments. In FIG. 9, the components of a gaming network 900 for providing game software licensing and downloads are described functionally. The described functions may be instantiated in hardware, firmware and/or software and executed on a suitable device. In the gaming network 900, there may be many instances of the same function, such as multiple game play interfaces 911. Nevertheless, in FIG. 9, only one instance of each function is shown. The functions of the components may be combined. For example, a single device may comprise the game play interface 911 and include trusted memory devices or sources 909.

The gaming network 900 may receive inputs from different groups/entities and output various services and or information to these groups/entities. For example, game players 925 primarily input cash or indicia of credit into the gaming network, make game selections that trigger software downloads, and receive entertainment in exchange for their inputs. Game software content providers 915 provide game software for the gaming network and may receive compensation for the content they provide based on licensing agreements with the gaming machine operators. Gaming machine operators select game software for distribution, distribute the game software on the gaming devices in the gaming network 900, receive revenue for the use of their software and compensate the gaming machine operators. The gaming regulators 930 may provide rules and regulations that must be applied to the gaming network and may receive reports and other information confirming that rules are being obeyed.

In the following paragraphs, details of each component and some of the interactions between the components are described with respect to FIG. 9. The game software license host 901 may be a server connected to a number of remote gaming devices that provides licensing services to the remote gaming devices. For example, in other embodiments, the license host 901 may 1) receive token requests for tokens used to activate software executed on the remote gaming devices, 2) send tokens to the remote gaming devices, 3) track token usage and 4) grant and/or renew software licenses for software executed on the remote gaming devices. The token usage may be used in utility based licensing schemes, such as a pay-per-use scheme.

In another embodiment, a game usage-tracking host 914 may track the usage of game software on a plurality of devices in communication with the host. The game usage-tracking host 914 may be in communication with a plurality of game play hosts and gaming machines. From the game play hosts and gaming machines, the game usage tracking host 914 may receive updates of an amount that each game available for play on the devices has been played and on amount that has been wagered per game. This information may be stored in a database and used for billing according to methods described in a utility based licensing agreement.

The game software host 902 may provide game software downloads, such as downloads of game software or game firmware, to various devious in the game system 900. For example, when the software to generate the game is not available on the game play interface 911, the game software host 902 may download software to generate a selected game of chance played on the game play interface. Further, the game software host 902 may download new game content to a plurality of gaming machines via a request from a gaming machine operator.

In one embodiment, the game software host 902 may also be a game software configuration-tracking host 913. The function of the game software configuration-tracking host is to keep records of software configurations and/or hardware configurations for a plurality of devices in communication with the host (e.g., denominations, number of paylines, paytables, max/min bets). Details of a game software host and a game software configuration host that may be used with example embodiments are described in co-pending U.S. Pat. No. 6,645,077, by Rowe, entitled, “Gaming Terminal Data Repository and Information System,” filed Dec. 21, 2000, which is incorporated herein in its entirety and for all purposes.

A game play host device 903 may be a host server connected to a plurality of remote clients that generates games of chance that are displayed on a plurality of remote game play interfaces 911. For example, the game play host device 903 may be a server that provides central determination for a bingo game play played on a plurality of connected game play interfaces 911. As another example, the game play host device 903 may generate games of chance, such as slot games or video card games, for display on a remote client. A game player using the remote client may be able to select from a number of games that are provided on the client by the host device 903. The game play host device 903 may receive game software management services, such as receiving downloads of new game software, from the game software host 902 and may receive game software licensing services, such as the granting or renewing of software licenses for software executed on the device 903, from the game license host 901.

In particular embodiments, the game play interfaces or other gaming devices in the gaming network 900 may be portable devices, such as electronic tokens, cell phones, smart cards, tablet PC's and PDA's. The portable devices may support wireless communications and thus, may be referred to as wireless mobile devices. The network hardware architecture 916 may be enabled to support communications between wireless mobile devices and other gaming devices in gaming network. In one embodiment, the wireless mobile devices may be used to play games of chance.

The gaming network 900 may use a number of trusted information sources. Trusted information sources 904 may be devices, such as servers, that provide information used to authenticate/activate other pieces of information. CRC values used to authenticate software, license tokens used to allow the use of software or product activation codes used to activate to software are examples of trusted information that might be provided from a trusted information source 904. Trusted information sources may be a memory device, such as an EPROM, that includes trusted information used to authenticate other information. For example, a game play interface 911 may store a private encryption key in a trusted memory device that is used in a private key-public key encryption scheme to authenticate information from another gaming device.

When a trusted information source 904 is in communication with a remote device via a network, the remote device will employ a verification scheme to verify the identity of the trusted information source. For example, the trusted information source and the remote device may exchange information using public and private encryption keys to verify each other's identities. In another example of an embodiment, the remote device and the trusted information source may engage in methods using zero knowledge proofs to authenticate each of their respective identities. Details of zero knowledge proofs that may be used with example embodiments are described in US publication no. 2003/0203756, by Jackson, filed on Apr. 9, 2002 and entitled, “Authentication in a Secure Computerized Gaming network, which is incorporated herein in its entirety and for all purposes.

Gaming devices storing trusted information might utilize apparatus or methods to detect and prevent tampering. For instance, trusted information stored in a trusted memory device may be encrypted to prevent its misuse. In addition, the trusted memory device may be secured behind a locked door. Further, one or more sensors may be coupled to the memory device to detect tampering with the memory device and provide some record of the tampering. In yet another example, the memory device storing trusted information might be designed to detect tampering attempts and clear or erase itself when an attempt at tampering has been detected.

The gaming network 900 of example embodiments may include devices 906 that provide authorization to download software from a first device to a second device and devices 907 that provide activation codes or information that allow downloaded software to be activated. The devices, 906 and 907, may be remote servers and may also be trusted information sources. One example of a method of providing product activation codes that may be used with example embodiments is describes U.S. Pat. No. 6,264,561, the entirety of which is incorporated herein by reference for all purposes.

A device 906 that monitors a plurality of gaming devices to determine adherence of the devices to gaming jurisdictional rules 908 may be included in the gaming network 900. In one embodiment, a gaming jurisdictional rule server may scan software and the configurations of the software on a number of gaming devices in communication with the gaming rule server to determine whether the software on the gaming devices is valid for use in the gaming jurisdiction where the gaming device is located. For example, the gaming rule server may request a digital signature, such as CRC's, of particular software components and compare them with an approved digital signature value stored on the gaming jurisdictional rule server.

Further, the gaming jurisdictional rule server may scan the remote gaming device to determine whether the software is configured in a manner that is acceptable to the gaming jurisdiction where the gaming device is located. For example, a maximum bet limit may vary from jurisdiction to jurisdiction and the rule enforcement server may scan a gaming device to determine its current software configuration and its location and then compare the configuration on the gaming device with approved parameters for its location.

A gaming jurisdiction may include rules that describe how game software may be downloaded and licensed. The gaming jurisdictional rule server may scan download transaction records and licensing records on a gaming device to determine whether the download and licensing was carried out in a manner that is acceptable to the gaming jurisdiction in which the gaming device is located. In general, the game jurisdictional rule server may be utilized to confirm compliance to any gaming rules passed by a gaming jurisdiction when the information needed to determine rule compliance is remotely accessible to the server.

Game software, firmware or hardware residing a particular gaming device may also be used to check for compliance with local gaming jurisdictional rules. In one embodiment, when a gaming device is installed in a particular gaming jurisdiction, a software program including jurisdiction rule information may be downloaded to a secure memory location on a gaming machine or the jurisdiction rule information may be downloaded as data and utilized by a program on the gaming machine. The software program and/or jurisdiction rule information may be used to check the gaming device software and software configurations for compliance with local gaming jurisdictional rules. In another embodiment, the software program for ensuring compliance and jurisdictional information may be installed in the gaming machine prior to its shipping, such as at the factory where the gaming machine is manufactured.

The gaming devices in game system 900 may utilize trusted software and/or trusted firmware. Trusted firmware/software is trusted in the sense that is used with the assumption that it has not been tampered with. For instance, trusted software/firmware may be used to authenticate other game software or processes executing on a gaming device. As an example, trusted encryption programs and authentication programs may be stored on an EPROM on the gaming machine or encoded into a specialized encryption chip. As another example, trusted game software, e.g., game software approved for use on gaming devices by a local gaming jurisdiction may be required on gaming devices on the gaming machine.

In example embodiments, the devices may be connected by a network 916 with different types of hardware using different hardware architectures. Game software can be quite large and frequent downloads can place a significant burden on a network, which may slow information transfer speeds on the network. For game-on-demand services that require frequent downloads of game software in a network, efficient downloading is essential for the service to viable. Thus, in example embodiments, network efficient devices 910 may be used to actively monitor and maintain network efficiency. For instance, software locators may be used to locate nearby locations of game software for peer-to-peer transfers of game software. In another example, network traffic may be monitored and downloads may be actively rerouted to maintain network efficiency.

One or more devices in example embodiments may provide game software and game licensing related auditing, billing and reconciliation reports to server 912. For example, a software licensing billing server may generate a bill for a gaming device operator based upon a usage of games over a time period on the gaming devices owned by the operator. In another example, a software auditing server may provide reports on game software downloads to various gaming devices in the gaming network 900 and current configurations of the game software on these gaming devices.

At particular time intervals, the software auditing server 912 may also request software configurations from a number of gaming devices in the gaming network. The server may then reconcile the software configuration on each gaming device. In one embodiment, the software auditing server 912 may store a record of software configurations on each gaming device at particular times and a record of software download transactions that have occurred on the device. By applying each of the recorded game software download transactions since a selected time to the software configuration recorded at the selected time, a software configuration is obtained. The software auditing server may compare the software configuration derived from applying these transactions on a gaming device with a current software configuration obtained from the gaming device. After the comparison, the software-auditing server may generate a reconciliation report that confirms that the download transaction records are consistent with the current software configuration on the device. The report may also identify any inconsistencies. In another embodiment, both the gaming device and the software auditing server may store a record of the download transactions that have occurred on the gaming device and the software auditing server may reconcile these records.

There are many possible interactions between the components described with respect to FIG. 9. Many of the interactions are coupled. For example, methods used for game licensing may affect methods used for game downloading and vice versa. For the purposes of explanation, details of a few possible interactions between the components of the gaming network 900 relating to software licensing and software downloads have been described. The descriptions are selected to illustrate particular interactions in the game system 900. These descriptions are provided for the purposes of explanation only and are not intended to limit the scope of example embodiments described herein.

Although several example embodiments of one or more aspects and/or features have been described in detail herein with reference to the accompanying drawings, it is to be understood that aspects and/or features are not limited to these precise embodiments, and that various changes and modifications may be effected therein by one skilled in the art without departing from the scope of spirit of the invention(s) as defined, for example, in the appended claims.

It is claimed:

1. A computer-implemented gaming method implemented in a gaming network, the method comprising:
causing a controller of a computerized wagering system to execute a plurality of instructions, which are stored in a memory device, to control a first wager-based gaming session;
enabling a Challenge Initiator to selectively customize and define an accomplishment-based, wager-based Challenge Offer (“Challenge Offer”), the Challenge Offer defining a first set of accomplishment criteria and defining a first set of wager criteria;
receiving, at the computerized wagering system, a first request to initiate the Challenge Offer;
receiving, at the computerized wagering system, information relating to the Challenge Offer including the first set of accomplishment criteria and first set of wager criteria;
publishing the Challenge Offer to at least one challenger;
receiving, at the computerized wagering system, a first Challenge Offer acceptance from a first challenger desiring to participate in the Challenge Offer;
automatically initiating, in response to detection of a first set of conditions and/or events, a start of a first accomplishment-based, wager-based challenge session (“first challenge session”) associated with the Challenge Offer;
enabling the first challenger to participate in the first challenge session;
automatically initiating, in response to detection of a second set of conditions and/or events, an end of the first challenge session;
automatically determining a final outcome or result of the first challenge session; and
automatically distributing, using information relating to the final outcome or result of the first challenge session, wager-related winnings and/or losses to the first challenger and Challenge Initiator.

2. The method of claim 1 further comprising:
automatically determining wager distributions relating to the first challenge session which are to be distributed to the first challenger and Challenge Initiator, wherein the determination of the wager distributions is at least partially based upon the final outcome or result of the first challenge session.

3. The method of claim 1:
wherein the determination of the final outcome or result of the first Challenge session includes automatically determining whether or not the first challenger has been successful in satisfying or completing the first set of accomplishment criteria before the end of the first challenge session.

4. The method of claim 1 further comprising:
automatically determining whether or not the first challenger was successful in satisfying or completing the first set of accomplishment criteria before the end of the first challenge session;
if it is determined that the first challenger has been successful in satisfying or completing the first set of accomplishment criteria before the end of the first challenge session, distributing a first payout to the first challenger in accordance with terms and conditions defined by the first set of wager criteria; and
if it is determined that the first challenger has not been successful in satisfying or completing the first set of accomplishment criteria before the end of the first challenge session, distributing a second payout to the Challenge Initiator in accordance with the terms and conditions defined by the first set of wager criteria.

5. The method of claim 1 further comprising:
automatically tracking status updates relating to asynchronous events, conditions, and/or activities associated with the first challenge session.

6. The method of claim 1:
wherein the first set of conditions and/or events for triggering the start of the first challenge session is defined by Challenge start criteria associated with the Challenge Offer; and
wherein the second set of conditions and/or events for triggering the end of the first challenge session is defined by Challenge end criteria associated with the Challenge Offer.

7. The method of claim 1 further comprising:
verifying, at the computerized wagering system and using the wager criteria, that the Challenge Initiator has provided access to a sufficient amount fungible resources to cover a first Challenge wager as defined by the first set of wager criteria.

8. The method of claim 1 further comprising:
verifying, at the computerized wagering system and using the wager criteria, that the Challenge Initiator has provided access to a sufficient amount fungible resources to cover a first Challenge wager as defined by the first set of wager criteria; and
verifying, at the computerized wagering system and using the wager criteria, that the first challenger has provided access to a sufficient amount fungible resources to cover a second Challenge wager as defined by the first set of wager criteria.

9. The method of claim 1 further comprising:
enabling the first challenger to selectively customize and define Challenge Counter Offer, the Challenge Counter Offer defining a first set of modified accomplishment criteria and/or defining a first set of modified wager criteria; and
submitting, via the computerized wagering system, the Challenge Counter Offer to the Challenge Initiator.

10. The method of claim 1 further comprising:
preventing publication of the Challenge Offer in response to determining that the first set of accomplishment criteria and/or the first set of wager criteria is not in compliance with a first set of rules or regulations.

11. The method of claim 1 wherein the first set of accomplishment criteria specifies at least one type of accomplishment parameter selected from a group consisting of: time-based criteria; score-based criteria; achievement-based criteria; and statistical criteria.

12. A computerized wagering system implemented in a wagering network, the system comprising:
at least one processor;
at least one interface operable to establish a communication link to at least one network device; and
a memory storing a plurality of instructions;
the at least one processor being operable to execute the plurality of instructions stored in the memory, and being operable to operate with the memory and the at least one interface to:
cause a controller of a computerized wagering system to execute a plurality of instructions, which are stored in a memory device, to control a first wager-based gaming session;
enable a Challenge Initiator to selectively customize and define an accomplishment-based, wager-based Challenge Offer (“Challenge Offer”), the Challenge Offer defining a first set of accomplishment criteria and defining a first set of wager criteria;
receive, at the computerized wagering system, a first request to initiate the Challenge Offer;
receive, at the computerized wagering system, information relating to the Challenge Offer including the first set of accomplishment criteria and first set of wager criteria;
publish the Challenge Offer to at least one challenger;
receive, at the computerized wagering system, a first Challenge Offer acceptance from a first challenger desiring to participate in the Challenge Offer;
automatically initiating, in response to detection of a first set of conditions and/or events, a start of a first accomplishment-based, wager-based challenge session (“first challenge session”) associated with the Challenge Offer;
enable the first challenger to participate in the first challenge session;
automatically initiating, in response to detection of a second set of conditions and/or events, an end of the first challenge session;
automatically determine a final outcome or result of the first challenge session; and
automatically distribute, using information relating to the final outcome or result of the first challenge session, wager-related winnings and/or losses to the first challenger and Challenge Initiator.

13. The system of claim 12 being further operable to:
automatically determine wager distributions relating to the first challenge session which are to be distributed to the first challenger and Challenge Initiator, wherein the determination of the wager distributions is at least partially based upon the final outcome or result of the first challenge session.

14. The system of claim 12 being further operable to:
automatically determine whether or not the first challenger was successful in satisfying or completing the first set of accomplishment criteria before the end of the first challenge session;
if it is determined that the first challenger has been successful in satisfying or completing the first set of accomplishment criteria before the end of the first challenge session, distribute a first payout to the first challenger in accordance with terms and conditions defined by the first set of wager criteria; and
if it is determined that the first challenger has not been successful in satisfying or completing the first set of accomplishment criteria before the end of the first challenge session, distribute a second payout to the Challenge Initiator in accordance with the terms and conditions defined by the first set of wager criteria.

15. The system of claim 12:
wherein the first set of conditions and/or events for triggering the start of the first challenge session is defined by Challenge start criteria associated with the Challenge Offer; and
wherein the second set of conditions and/or events for triggering the end of the first challenge session is defined by Challenge end criteria associated with the Challenge Offer.

16. The system of claim 12 being further operable to:
verify, at the computerized wagering system and using the wager criteria, that the Challenge Initiator has provided access to a sufficient amount fungible resources to cover a first Challenge wager as defined by the first set of wager criteria.

17. The system of claim 12 being further operable to:
verify, at the computerized wagering system and using the wager criteria, that the Challenge Initiator has provided access to a sufficient amount fungible resources to cover a first Challenge wager as defined by the first set of wager criteria; and
verify, at the computerized wagering system and using the wager criteria, that the first challenger has provided access to a sufficient amount fungible resources to cover a second Challenge wager as defined by the first set of wager criteria.

18. The system of claim 12 being further operable to:
enable the first challenger to selectively customize and define Challenge Counter Offer, the Challenge Counter Offer defining a first set of modified accomplishment criteria and/or defining a first set of modified wager criteria; and
submit, via the computerized wagering system, the Challenge Counter Offer to the Challenge Initiator.

19. The system of claim 12 being further operable to:
prevent publication of the Challenge Offer in response to determine that the first set of accomplishment criteria and/or the first set of wager criteria is not in compliance with a first set of rules or regulations.

20. A computerized wagering system implemented in a wagering network, the system comprising:
a controller of a computerized wagering system to execute a plurality of instructions, which are stored in a memory device, to control a first wager-based gaming session;
means for enabling a Challenge Initiator to selectively customize and define an accomplishment-based, wager-based Challenge Offer (“Challenge Offer”), the Challenge Offer defining a first set of accomplishment criteria and defining a first set of wager criteria;
means for receiving, at the computerized wagering system, a first request to initiate the Challenge Offer;
means for receiving, at the computerized wagering system, information relating to the Challenge Offer including the first set of accomplishment criteria and first set of wager criteria;
means for publishing the Challenge Offer to at least one challenger;
means for receiving, at the computerized wagering system, a first Challenge Offer acceptance from a first challenger desiring to participate in the Challenge Offer;
means for automatically initiating, in response to detection of a first set of conditions and/or events, a start of a first accomplishment-based, wager-based challenge session (“first challenge session”) associated with the Challenge Offer;
means for enabling the first challenger to participate in the first challenge session;
means for automatically initiating, in response to detection of a second set of conditions and/or events, an end of the first challenge session;
means for automatically determining a final outcome or result of the first challenge session; and
means for automatically determining whether or not the first challenger was successful in satisfying or completing the first set of accomplishment criteria before the end of the first challenge session; and
means for automatically distributing, using information relating to the final outcome or result of the first challenge session, wager-related winnings and/or losses to the first challenger and Challenge Initiator.
